(19) United States
(12) Patent Application Publication
(10) Pub. No.: US 2006/0063273 A1
(43) Pub. Date: Mar. 23, 2006

(54) Separating apparatus, separating method, and mass analyzing system

(75) Inventors: Minoru Asogawa, Tokyo (JP); Masakazu Baba, Tokyo (JP); Hisao Kawaura, Tokyo (JP); Toru Sano, Tokyo (JP); Kazuhiro Iida, Tokyo (JP); Noriyuki Iguchi, Tokyo (JP); Hiroko Someya, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/536,908

(22) PCT Filed: Dec. 1, 2003
(86) PCT No.: PCT/JP03/15339

§ 371 Date: May 27, 2005

(30) Foreign Application Priority Data
Nov. 29, 2002 (JP) 2002-349282

(51) Int. Cl. G01N 1/10

(52) U.S. Cl. 436/180

(57) ABSTRACT

Individual components are separated with a high concentration and accurately, from a sample containing components-to-be-separated. The separation apparatus includes a channel through which a sample containing components-to-be-separated moves; and gateway portions partitioning the separation channel into a plurality of compartments. The separation apparatus further includes an external force imposing unit, which imposes external force to the components-to-be-separated so as to allow them to move through the channel. The external force imposing unit is configured so as to alternately repeatedly execute a first external force imposing pattern by which the external force is imposed in the forward direction of the channel, and a second external force imposing pattern by which the external force is imposed in the direction opposite to the forward direction along the channel. This makes it possible to fractionate the components-to-be-separated into any of the compartments.

### BACKGROUND OF THE INVENTION

1. Field of the Invention

The present invention relates to a separation apparatus, a method of separation, and a mass spectrometry apparatus, used for separating a specific component from a plurality of components contained in a sample.

2. Description of the Related Art

In the conventional research fields of proteomics and genomics, proteins, peptides, or fragments of nucleic acids such as DNA are analyzed after being separated by electrophoresis, and recovered from gel. In electrophoresis using a microchip, as shown in FIG. 22(a), a channel for introduction 302 and a channel for separation 304 are formed in a cross form on a substrate 300. First, as shown in FIG. 22(b), a sample is introduced from a fluid reservoir 306 to move rightward in the drawing by applying an electric field in the lateral direction of the drawing, and then, as shown in FIG. 22(c), to flow into the channel for separation by applying an electric field in the vertical direction of the drawing, which is successful in separating components differing in the migration range.

Patent Document 1: Japanese Laid-Open Patent Publication No. 2002-131280

### SUMMARY OF THE INVENTION

A small amount of the sample introduced from the channel for introduction into the channel for separation can, however, only yield a slight amount of target component. Failure in obtaining the target components with a high concentration raises a problem of degradation in accuracy of the analysis. On the other hand, widening of the channel for introduction, aiming to increase the amount of sample introduced into the channel for separation, broadens bands of the sample flowing through the channel for separation, degrades the resolution, and results in only an inaccurate separation. Charging of a high concentration of sample, despite the channel for introduction is remained narrow, also results in aggregation of the sample itself, degrades the resolution, and fails in carrying out a desirable separation.

The present invention is conceived after considering the above-described situation, and an object of which is to provide a technique making it possible to efficiently separate a sample by a simple operation. The present invention is also aimed at providing a technique capable of accurately separating a sample, and at the same time, recovering it after being concentrated.

According to the present invention, there is provided a separation apparatus which includes a channel through which a sample containing components-to-be-separated moves; one, or two or more check valves disposed in the channel, suppressing back flow of the components-to-be-separated; a plurality of compartments partitioned by the check valves; and an external force imposing unit imposing external force to the components-to-be-separated so as to allow them to move through the channel, wherein the external force imposing unit has a function of alternately executing a first external force imposing pattern by which the external force is imposed to the components-to-be-separated in the forward direction along the channel, and a second external force imposing pattern by which the external force is imposed to the components-to-be-separated in the direction opposite to the forward direction along the channel, to thereby fractionate the components-to-be-separated into any of the compartments.

This configuration allows the components-to-be-separated to move through the channel respectively at their specific speeds, and a component passed through one compartment when the first external force imposing pattern was executed is prevented from flowing back into a compartment which resides on the side opposite to the forward direction of the channel even when the second external force imposing pattern is executed, so that it is made possible to separate the individual components-to-be-separated into any of the compartments depending on their specific migration ranges. The migration ranges of the individual components-to-be-separated herein are determined by properties of the individual components, magnitude of the external force, and application time of the external force. This makes it possible to separate and concentrate the components-to-be-separated. It is to be noted herein that imposition of the external force in the forward direction of the channel means that a force causing sample movement in the individual compartments in the forward direction of the channel is imposed. It is also to be noted herein that imposition of the external force in the direction opposite to the forward direction of the channel means that a force causing sample movement in the individual compartments in the direction opposite to the forward direction of the channel is imposed.

In the separation apparatus of the present invention, the channel may be formed so as to extend in a straight form.

This makes it possible to simplify the configuration, because the directions of application of the external force are limited to only one direction and the opposite direction. If the individual components are separated into the individual compartments, and the external force is imposed unidirectionally, the sample separated into the individual compartments can sequentially be recovered on the downstream side of the channel.

In the separation apparatus of the present invention, the check valves may be formed so as to block back flow of at least a part of the components-to-be-separated flew through each of the check valves and moved to the downstream side of the channel.

The check valves per se herein are preferably composed of a material not electrically affective to the components-to-be-separated in the sample. The check valves may typically be configured by a plurality of columnar structures arranged at intervals narrow enough to prevent the components-to-be-separated from passing therethrough. Materials for composing the check valve may be anything provided that they are not electrically affective to the components-to-be-separated in the sample as described in the above, and may typically be a conductive member. The check valves herein are successful enough if they can function as valves, and may be formed so as to have a variety of structures and geometries. Even if the components moved to the compartments on the downstream side of the channel should flow back into the compartments on the upstream side, repetitive execution of the first external force imposing pattern and second external force imposing pattern makes the individual components move towards the compartments on the downstream side in a geometric series manner depending on their specific migration ranges, so that it is made possible to finally separate the individual components into the individual compartments, and concentrate them.

In the separation apparatus of the present invention, the external force imposing unit may include a plurality of electrodes provided to both ends of the channel, and may have a function of executing the first external force imposing pattern and the second external force imposing pattern by changing direction of voltage to be applied between the electrodes. The electrodes herein are not limited to those provided on both ends of the channel, but may have any arrangement so far as they can allow the sample to move within the individual compartments in the forward direction and the opposite direction of the channel.

According to the present invention, there is provided a separation apparatus comprising a channel through which a sample containing components-to-be-separated moves; interception units intercepting the components-to-be-separated moving through the channel in the sample forwarding direction of the channel; a plurality of compartments partitioned by adjacent ones of the interception units; and an external force imposing unit imposing external force to the components-to-be-separated so as to allow them to move through the channel, wherein the external force imposing unit is configured so as to sequentially execute a plurality of external force imposing patterns differing in external force component in the sample forwarding direction in the channel in the individual compartments, and has a function of sequentially executing the plurality of external force imposing patterns so as to fractionate the components-to-be-separated into any of the compartments.

According to this configuration, in the compartment in which the external force imposing pattern causing positive external force component in the sample forwarding direction of the channel is executed, the components-to-be-separated move in the sample forwarding direction of the channel at their specific speeds depending on length of the compartment, and in the compartment in which the external force imposing pattern causing negative external force component in the sample forwarding direction of the channel is executed, the components-to-be-separated move in the direction opposite to the sample forwarding direction of the channel. Because it is made possible to move the component passed through the interception unit into the next compartment by imposing the next pattern, the individual components can be separated into any of the compartments depending on their specific migration ranges, by sequentially repeating a plurality of external force imposing patterns. This makes it possible to separate and concentrate the components-to-be-separated.

In the separation apparatus of the present invention, the external force imposing unit may be configured to impose external force so as to substantially equalize magnitude of the external force imposed to the components-to-be-separated in each of the compartments.

Here, substantially equalize magnitude of the external force means that the external force is imposed so that the components-to-be-separated, which should intrinsically move at the same speed, can move at the same speed in all compartments. In an exemplary case where the external force is imposed by applying voltage to electrodes provided to both ends of the individual compartments, the external force imposing unit is configured so as to set potential applied to the individual electrodes, considering length of the individual compartments. The electrodes herein are not limited to those provided on both ends of the individual compartments, but may have any arrangement so far as they can allow the sample to move within the individual compartments in the forward direction and the opposite direction of the channel.

In the separation apparatus of the present invention, the external force imposing pattern may be such as imposing external force so that the compartments expressing a positive external force component and the compartments expressing a negative external force component alternately appear along the sample forwarding direction of the channel.

Because the components passed through the interception unit move to the next compartment upon being applied with the next pattern, and move through the compartment, the individual components can be separated into any of the compartments depending on their specific migration ranges by sequentially repeating the plurality of external force imposing patterns. This makes it possible to separate and concentrate the components-to-be-separated.

In the separation apparatus of the present invention, the channel may have a bent geometry, and a bent portion of the channel may configure the interception unit.

Because the components reached the bent portion move to the next compartment upon being applied with the next pattern, and move through the compartment, the individual components can be separated into any of the compartments depending on their specific migration ranges by sequentially repeating the plurality of external force imposing patterns. This makes it possible to separate and concentrate the components-to-be-separated.

In the separation apparatus of the present invention, the bent portion may be formed substantially at right angles.

With this structure, almost all portions of the components reached the bent portion move to the next compartment upon being applied with the next pattern, and move through the compartment, the individual components-to-be-separated can efficiently be separated and concentrated, even if the number of times of repetition of the external force imposing patterns is reduced.

The separation apparatus of the present invention may further include recovery units recovering the components-to-be-separated fractionated into the individual compartments from the interception units, wherein the external force imposing unit may impose external force also between each of the recovery units and the interception units, so as to move the sample towards the interception unit during fractionation of the sample, and so as to move the sample towards the recovery unit during recovery of the sample.

This configuration makes it possible to recover the individual components-to-be-separated from the interception units provided to the individual compartments, without moving the components-to-be-separated separated into the individual compartments towards a destination of recovery on the downstream of the channel.

In the separation apparatus of the present invention, the plurality of compartments placed along the sample forwarding direction of the channel are configured so that the one placed on the further downstream side of the channel has a larger length.

In this configuration, any component having a larger migration speed reaches a further portion of the channel, and this makes it possible to separate the components into any of the compartments depending on their specific migration ranges, and to concentrate them within the compartments.

In the separation apparatus of the present invention, the plurality of compartments placed along the sample forwarding direction of the channel are configured so that the one placed on the further downstream side of the channel is imposed with a smaller external force in the individual external force imposing patterns.

With this structure, a component having a larger migration speed can go further in the advancing direction of the channel, and the individual components will move over a shorter distance from one compartment to the next compartment, in positions further in the advancing direction, therefore it makes it possible to carry out the separation in a more accurate manner.

In the separation apparatus of the present invention, the individual components-to-be-separated may be fractionated into any of the compartments depending on migration ranges caused by imposition of the external force.

The separation apparatus of the present invention may further include a recovery unit provided on the downstream side of the channel, and the external force imposing unit may be configured so as to gradually elongate imposition time of the external force in the individual imposing patterns, so that fractions of the components-to-be-separated can sequentially be obtained from the recovery unit.

In the separation apparatus of the present invention, the external force imposing unit is configured so as to execute an external force imposing pattern specialized for recovery, in which the external force is imposed in the forward direction of the channel for a duration of time longer than that in the individual external force imposing patterns, and may be configured so as to recover the components-to-be-separated from the compartment placed furthest on the downstream side of the channel, through execution of the external force imposing pattern specialized for recovery. If the imposition time of the external force in the external force imposing pattern specialized for recovery is adjusted to a time obtained by multiplying imposition time of the external force with a value calculated by dividing length of the compartment placed furthest on the downstream of the channel with length of the compartment placed just on the upstream side thereof, it is made possible to introduce components in the compartment on the upstream side into the channel specialized for recovery. If the imposition time of the external force is adjusted to a time not longer than the above-described time, only the components having relatively high speeds out of those contained in the compartments on the upstream side can be introduced into the channel specialized for recovery. This makes it possible to separate components having high migration speeds and components having not so high migration speeds, from those contained in the compartments on the downstream side of the channel, so that the individual components can be recovered in a concentrated and accurately separated manner.

According to the present invention, there is provided a method of separating components in a sample using any one of the above-described separation apparatuses, which includes a step of introducing the sample into the channel; a first step of executing any one of the external force imposing patterns so as to move, within one compartment, the sample towards the downstream side of the channel; a second step of executing any one of the external force imposing patterns so as to move, within one compartment, the sample towards the upstream side of the channel; wherein these steps being sequentially repeated.

In the separation method of the present invention, duration of time of imposing the external force may be kept constant for every execution, in the external force imposing pattern in the first step.

In the separation method of the present invention, duration of time of imposing the external force may be kept constant for every execution, in the external force imposing pattern in the first step, and in the external force imposing pattern in the second step.

In the separation method of the present invention, duration of time of imposing the external force in the external force imposing pattern in the second step is adjusted to substantially equal to, or longer than the duration of time of imposing the external force in the external force imposing pattern in the first step.

In the separation method of the present invention, it is allowable to repetitively execute the first step and the second step, to execute the step of introducing the sample again, and to further repeat similar steps.

In the separation method of the present invention, the first step and the second step may repetitively be executed while keeping duration of time of imposing the external force constant for every execution, in the external force imposing pattern in the first step and in the external force imposing pattern in the second step, and similar process may be repeated thereafter under an elongated duration of time of imposing the external force in the external force imposing pattern in at least the first step.

The separation method of the present invention may further include a step of executing an external force imposing pattern specialized for recovery, in which the external force is imposed to the sample so as to allow it to move towards the downstream side of the channel, for a duration of time longer than the duration of time of imposing the external force in the external force imposing pattern in the first step.

According to the present invention, there is provided a separation apparatus which includes a channel having a main channel and sub channels formed as being branched out from the main channel, through which a sample moves; and an external force imposing unit imposing external force to the components-to-be-separated so as to allow them to move through the channel, wherein the external force imposing unit is configured so as to sequentially execute a plurality of external force imposing patterns differing in direction of imposition of the external force relative to the channel, and configured so as to fractionate the components-to-be-separated into any of the sub channels, through execution of the plurality of external force imposing patterns.

This configuration allows the components-to-be-separated to move at the individual specific speeds through the channel, and execution of the external force imposing patterns differing in the direction of imposition of the external force successfully separates them into any of sub channels. This makes it possible to separate and concentrate the components-to-be-separated.

In the separation apparatus of the present invention, the main channel may have a sample introduction port; the sub channels may be configured so as to have the components-to-be-separated introduced thereinto when the external force imposing unit imposes external force towards the sample introduction port, and so as to move the components-to-be-separated towards the main channel when the external force imposing unit imposes external force in the direction departing from the sample introduction port.

In this configuration, the components moved through the main channel are separated into the sub channels when they flow back to the direction toward the sample introduction port, so that it is made possible to introduce the individual components into the sub channel, depending on their specific migration ranges.

In the separation apparatus of the present invention, the main channel may have a sample introduction port; and each of the sub channels may have a length almost equal to that of a portion of the main channel ranging from a point where the sub channel branches out from the main channel to the sample introduction port.

When the components separated into the sub channels are allowed to move to the end portion of the sub channel, a new sample is introduced into the sample introduction port, and the samples are allowed to move both from the sample introduction port and from the end portion of the sub channel at the same time, this configuration can bring the components which migrate at the same migration speed into confluence at the branching point of the main channel, and can recover the samples in a concentrated manner.

In the separation apparatus of the present invention, the main channel may have a sample introduction port; and each of the channels may have a length longer than that of a portion of the main channel ranging from a point where the sub channel branches out from the main channel to the sample introduction port.

This configuration makes it possible to keep the components once separated into the sub channels housed in the sub channel, without causing leakage thereof from the sub channel, and consequently makes it possible to concentrate the individual components in the sub channels.

The separation apparatus of the present invention may further include a check valve provided on the upstream side and in the vicinity of a point where the sub channel branches out from the main channel.

When the sample moves away from the sample introduction port, passing the branching point with the sub channel by, and moves back in the opposite direction, this configuration is successful in moving a larger amount of components into the sub channels, while suppressing the back flow towards the direction of sample introduction, and can efficiently separate and concentrate the components.

In the above-described separation apparatuses, it is also allowable to provide, on the downstream side of the main channel, a molecular weight separation region separating the individual components based on their molecular weights. This makes it possible to separate the individual components in an accurate manner.

In the separation apparatus of the present invention, the individual components-to-be-separated can respectively be fractionated into any of the compartments, depending on their migration ranges caused by imposition of the external force.

According to the present invention, there is provided a separation method separating components in a sample using any one of the separation apparatus described in the above, which includes a step of introducing the sample into the channel; a first step of executing, in the main channel, anyone of the external force imposing patterns so as to move the sample towards the downstream side of the channel; a second step of executing, in the main channel, any one of the external force imposing patterns so as to move the sample towards the upstream side of the channel; wherein these steps are sequentially repeated.

In the separation method of the present invention, in the external force imposing pattern in the first step, duration of time of imposing the external force may be kept constant for every execution.

In the separation method of the present invention, duration of time of imposing the external force in the external force imposing pattern in the second step may be adjusted to substantially equal to, or longer than the duration of time of imposing the external force in the external force imposing pattern in the first step.

In the separation method of the present invention, it is allowable to repetitively execute the first step and the second step, to execute the step of introducing the sample again, and to further repeat similar steps.

According to the present invention, there is provided a separation method using a separation apparatus comprising a channel through which a sample containing components-to-be-separated moves, a plurality of compartments provided to the channel, and an external force imposing unit imposing external force to the components-to-be-separated so as to allow them to move through the channel, wherein the external force is repetitively imposed sequentially in the direction departing from a sample introduction position and in the direction approaching the position on the channel, to thereby fractionate the components-to-be-separated into any of the compartments.

In the separation method of the present invention, the components-to-be-separated can be fractionated into any of the compartments depending on their migration ranges caused by imposition of the external force.

According to the present invention, there is provided a system which includes an external force switching control unit executing any one of the separation method described in the above.

According to the present invention, there is provided a mass spectrometry system which includes a separation unit separating a biological sample depending on the molecular size or properties; a pre-treatment unit subjecting the sample separated by the separation unit to a pre-treatment including an enzyme digestion treatment; a drying unit drying the enzyme-digestion-treated sample; and a mass spectrometry unit subjecting the dried sample to mass spectrometry, wherein the separation unit includes any one of separation apparatus explained in the above. The biological sample herein may be those extracted from living bodies, or may be synthesized ones.

According to the present invention, there is provided a mass spectrometry system which includes a pre-treatment unit separating a biological sample depending on the molecular size or properties, and subjecting the sample to a pre-treatment for an enzyme digestion treatment; a unit subjecting the sample pre-treated by the pre-treatment unit to the enzyme digestion treatment; a drying unit drying the enzyme-digestion-treated sample; and a mass spectrometry unit subjecting the dried sample to mass analysis, wherein the pre-treatment unit includes any one of microchips described in the above.

### BRIEF DESCRIPTION OF THE DRAWINGS

The above and other objects, advantages and features of the present invention will be more apparent from the following description of preferred embodiments taken in conjunction with the accompanying drawings.

FIG. 1 is a drawing showing a configuration of a separation apparatus according to an embodiment of the present invention.

FIG. 2 is a drawing explaining operations for separating components of a sample using the separation apparatus shown in FIG. 1.

FIG. 3 is a drawing explaining operations for separating components of a sample using a separation apparatus according to an embodiment of the present invention.

FIG. 4 is a drawing showing another example of the separation apparatus shown in FIG. 1.

FIG. 5 is a top view showing a configuration of a separation apparatus according to an embodiment of the present invention.

FIG. 6 is a drawing explaining operations for separating components of a sample using the separation apparatus shown in FIG. 5.

FIG. 7 is a drawing explaining operations for separating components of a sample using the separation apparatus shown in FIG. 5.

FIG. 8 is a drawing explaining operations for separating components of a sample using the separation apparatus shown in FIG. 5.

FIG. 9 is a drawing showing a modified example of the separation apparatus shown in FIG. 5.

FIG. 10 is a drawing showing a recovery unit of a separation apparatus according to an embodiment of the present invention.

FIG. 11 is a top view showing a configuration of a separation apparatus according to an embodiment of the present invention.

FIG. 12 is a drawing explaining operations for separating components of a sample using the separation apparatus shown in FIG. 11.

FIG. 13 is a drawing explaining operations for separating components of a sample using the separation apparatus shown in FIG. 11.

FIG. 14 is a top view showing a configuration of a separation apparatus according to an embodiment of the present invention.

FIG. 15 is a top view showing a configuration of a separation apparatus according to an embodiment of the present invention.

FIG. 16 is a drawing explaining operations for separating components of a sample using the separation apparatus shown in FIG. 15.

FIG. 17 is a drawing explaining operations for separating components of a sample using the separation apparatus shown in FIG. 15.

FIG. 18 is a top view showing a configuration of a separation apparatus according to an embodiment of the present invention.

FIG. 19 is a drawing showing a configuration of a gateway portion in detail.

FIG. 20 is a drawing showing process steps of manufacturing an electrode.

FIG. 21 is a top view showing a separation apparatus according to an embodiment.

FIG. 22 is a top view showing a configuration of a conventional separation apparatus.

FIG. 23 is a schematic drawing showing a configuration of a mass spectrometry apparatus.

FIG. 24 is a block diagram of a mass spectrometry system including the separation apparatus according to an embodiment of the present invention.

FIG. 25 is a chart showing an application pattern of voltage applied to a channel.

FIG. 26 is a chart showing an application pattern of voltage applied to a channel.

FIG. 27 is a top view showing a configuration of a separation apparatus according to an embodiment of the present invention.

FIG. 28 is a top view showing a configuration of a separation apparatus according to an embodiment of the present invention.

FIG. 29 is a top view showing a configuration of a separation apparatus according to an embodiment of the present invention.

### DETAILED DESCRIPTION OF THE INVENTION

The separation apparatus of the present invention is applicable to separation and concentration of a variety of components including cell and other components; solid components (fragment of cell membrane, mitochondria, endoplasmic reticulum) and liquid fraction (cytoplasm) out of components obtained by destroying cells; and high-molecular-weight components (DNA, RNA, protein, sugar chain) and low-molecular-weight-components (steroid, glucose, peptide, etc.) out of components contained in the liquid fraction.

The present invention can be targeted not only at these processing, but also at any samples containing components possibly showing different migration ranges under imposition of external force. The external force can be imposed typically by using a method of applying electric field so as to effect electrophoresis or electroosmosis, or a method of causing the migration by applying pressure using a pump.

Next paragraphs will describe embodiments of the present invention referring to the attached drawings.

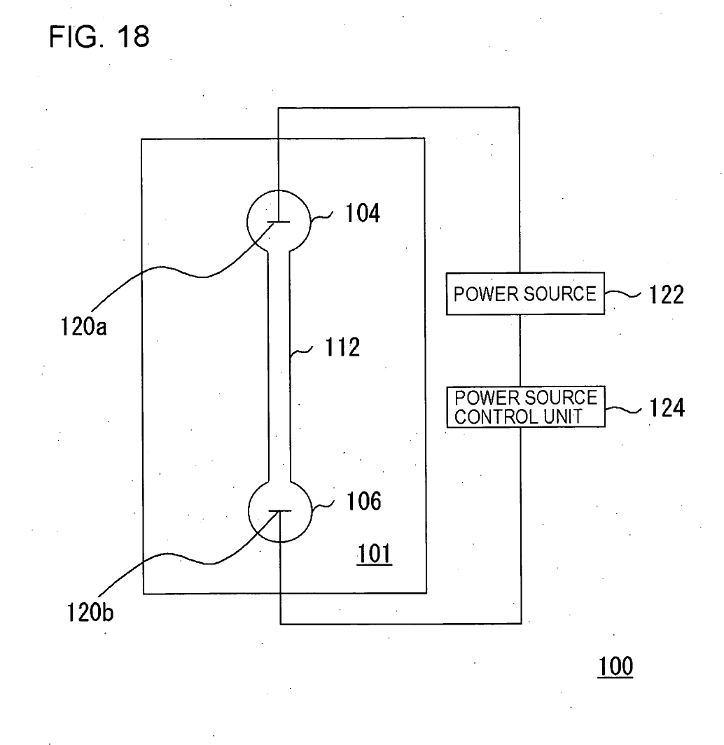

FIG. 18 is a drawing showing a configuration of this embodiment applied with a general separation apparatus. The separation apparatus 100 includes a sample introduction portion 104, a channel for separation (or separation fluid passageway) 112, and a sample recovery portion 106, all of which being formed on a substrate 101. The separation apparatus of the present invention may have any configurations without being limited to that shown in FIG. 18. In this embodiment, the sample introduction portion 104 and the sample recovery portion 106 are provided with an electrode 120a and an electrode 120b, respectively. The electrode 120a and the electrode 120b are connected to a power source 122 external of the substrate 101. The separation apparatus 100 further includes a power source control unit 124. The power source control unit 124 controls a voltage application pattern, including direction of voltage, potential, time and so forth, to be applied to the electrode 120a and the electrode 120b.

The substrate 101 may be a silicon substrate, a glass substrate such as made of quartz, or those composed of plastic material. The channel for separation 112 may be provided by forming a groove on this sort of substrate 101, but may be formed also by, for example, providing hydrophilic treatment to a hydrophobic substrate, or by providing hydrophobic treatment to wall portion of the channel for separation on the surface of a hydrophilic substrate. For the case where a plastic material is used for the substrate 101, the channel for separation 112 can be formed by any publicly-known methods suitable for the material composing the substrate 101, examples of which include etching, press forming using a die such as embossing, injection molding, and formation by photo-curing.

Width of the channel for separation 112 can appropriately be adjusted depending on purposes of the separation. In exemplary processing such as:
(i) separation and concentration of cells and other components;
(ii) separation and concentration of solid components (fragment of cell membrane, mitochondria, endoplasmic reticulum) and liquid fraction (cytoplasm) out of components obtained by destroying cells; and
(iii) separation and concentration of high-molecular-weight components (DNA, RNA, protein, sugar chain) and low-molecular-weight components (steroid, glucose, peptide, etc.) out of components contained in the liquid fraction, the width is adjusted to:
1 μm to 10 μm for case (i);
100 nm to 1 μm for case (ii); and
1 nm to 100 nm for case (iii).

### First Embodiment

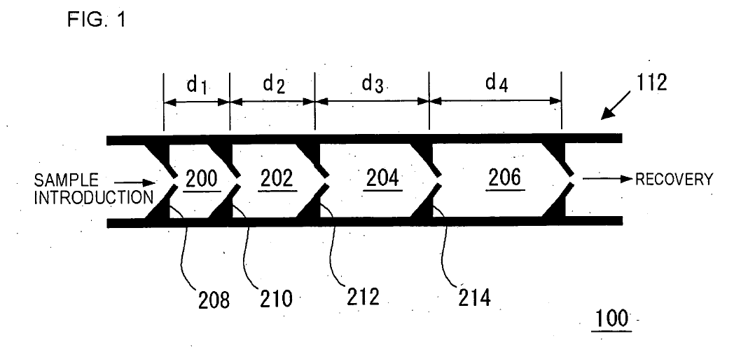

FIG. 1 is a drawing showing a part of a separation apparatus according to the first embodiment of the present invention.

The separation apparatus 100 has the channel for separation 112 partitioned by a plurality of compartments 200, 202, 204 and 206. A sample is introduced into the compartment 200, flows through the compartments 202, compartment 204 and compartment 206 in this order rightward in the drawing, and is recovered. The compartment 200, 202, 204 and 206 have lengths of d₁, d₂, d₃ and d₄, respectively. The individual compartments 200 to 206 are formed so that the one placed closer to the destination of recovery has a larger length. That is, the length d₁<the length d₂<the length d₃<the length d₄. The entrance of the compartment 200 and the boundaries between every adjacent compartments of compartments 200 to 206 have gateway portions 208, 210, 212, and 214 provided thereto, by which the sample is allowed to move towards the destination of recovery (rightward in the drawing), but is inhibited to move towards the sample introduction portion (leftward in the drawing). The gateway portions 208 to 214 can be composed of any materials having electric conductivity, details of which will be described later. Although not illustrated, the channel for separation 112 has electrodes provided to the sample introduction side and recovery side thereof, so as to allow control of voltage application pattern by the power source control unit 124 shown in FIG. 18.

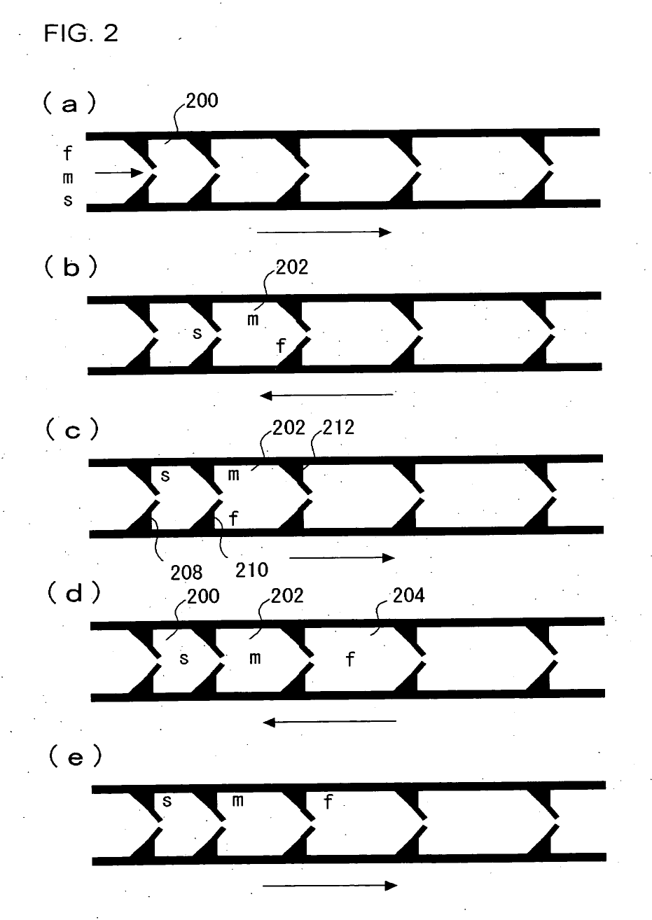

Operations of thus-formed channel for separation 112 introduced with a sample containing a plurality of components will be explained referring to FIG. 2.

First, as shown in FIG. 2(a), a sample containing three components f, m and s is introduced into the compartment 200, and voltage is applied so as to make the sample flow rightward in the drawing. This makes the individual components f, m and s move rightwards at their specific speeds. It is assumed herein that the component f flows fastest, component m flows second fastest, and component s flows slowest.

After being applied with the voltage for a predetermined duration of time, the component f having the largest migration speed and the component m having the middle migration speed move to the compartment 202 as shown in FIG. 2(b), but the component s having the smallest migration speed stays in the compartment 200 and moves only within the compartment 200. Thereafter, direction of voltage application is inverted, and the voltage is adjusted so as to allow the sample to flow leftward.

This makes the component f and component m move within the compartment 202 towards the direction of the gateway portion 210, and makes the component s move within the compartment 200 towards the direction of the gateway portion 208. Because the gateway portion 208 and the gateway portion 210 are provided between every adjacent compartments, the component f and the component m are intercepted by the gateway portion 210, and the component s is intercepted by the gateway portion 208, as shown in FIG. 2(c).

In this state, direction of the voltage application is inverted again, and the voltage is applied so as to make the sample flow rightward in the drawing. After the voltage application for a predetermined duration of time, as shown in FIG. 2(d), the component f having the largest migration speed moves to the compartment 204, but the component m having the middle migration speed stays in the compartment 202 and moves only within the compartment 202. The component s having the smallest migration speed stays in the compartment 200, and moves only within the compartment 200. Then, direction of the voltage application is inverted again, and the voltage is applied so as to make the sample flow leftward in the drawing.

In this state, as shown in FIG. 2(e), the individual components f, m and s are intercepted again by the gateway portions 212, 210 and 208 which reside on the left hand sides, in the drawing, of the compartment 204, compartment 202 and compartment 200, respectively.

Direction of the voltage application is inverted again so as to make the sample flow rightward in the drawing, and thereafter the alternative inversion of the direction of voltage application are repeated. In this process, the voltage allowing the sample to flow towards the destination of recovery is preferably applied for a constant duration of time for every application. Although the duration of time, over which the voltage is applied to make the sample flow towards the sample introduction portion, is not always necessarily be kept constant for every application, the duration of time is preferably adjusted long enough to allow the samples contained in the individual compartments to reach the gateway portions which reside on the left hand side of these compartments.

In this configuration, any components having migration ranges of smaller than d₁, under voltage application for a predetermined duration of time, keep on staying within the compartment 200, and cannot move to the next compartment 202. Similarly, any components having migration ranges of smaller than d₂, under voltage application for a predetermined duration of time, keep on staying within the compartment 202, any components having migration ranges of smaller than d₃, under voltage application for a predetermined duration of time, keep on staying within the compartment 204, and any components having migration ranges of smaller than d₄, under voltage application for a predetermined duration of time, keep on staying within the compartment 206. Because the individual compartments 200 to 206 are formed so that the one placed closer to the right hand side have a larger length, it is typically made possible to allow any components having migration ranges of not smaller than d₁ and smaller than d₂, under voltage application for a predetermined duration of time, keep on staying within the compartment 202.

When the components f, m and s in the sample introduced into the compartment 200 are separated as shown in FIG. 2(e), the next lot of sample is introduced again into the compartment 200, and similar processes are repeated, the individual components in the sample initially introduced can keep staying within the individual compartments depending on their specific migration ranges, and can be gathered with the same components in the sample of the next lot, so that the individual components can be separated in a concentrated manner.

As described in the above, by providing the channel for separation 112 with a plurality of compartments 200 to 206 so that the one placed closer to the destination of recovery has a larger length, and by alternately repeating migration towards the destination of recovery and towards the sample introduction portion, the components in the sample can be separated into any of the compartments 200 to 206 depending on their specific migration ranges, and can gradually be fractionated.

When the voltage is applied so as to make the sample flow towards the destination of recovery, elongation of duration of time of voltage application results in increase in the rightward migration ranges of the individual components. When the duration of time of voltage application is increased to a slight degree, only a component having the largest migration speed, out of the components being kept on staying in the compartment 206, for example, is eluted from the compartment 206. This makes it possible to recover only the component having the largest migration speed, out of the components having been fractionated into the compartment 206, can be recovered. Next, when a similar voltage application cycle is repeated while elongating the duration of time of voltage application a little longer, the individual compartments will have, fractionated therein, the components which can migrate over at least distances corresponded to the lengths of the compartments placed on the left hand side within the application time. Elongation again of the duration of time of voltage application results, for example, in elution of the component having the largest migration speed, out of the components having been kept on staying in the compartment 206, from the compartment 206. Repetition of these processes makes it possible to separate and recover the individual components in a concentrated and accurate manner.

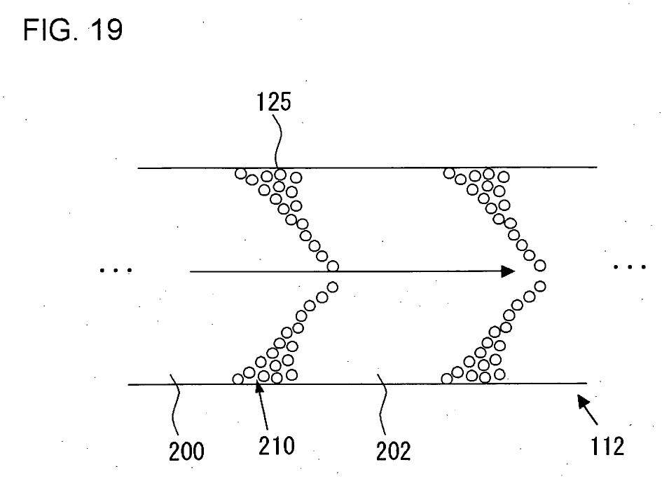

Next paragraphs will describe configuration of the gateway portions 208 to 214. Because the gateway portion 208 to 214 have the same configuration, only a configuration of the gateway portion 210 will be shown. As shown in FIG. 19, the gateway portion 210 of the present embodiment is configured by a plurality of pillars 125. The pillar 125 herein refers to a tiny columnar structure having a geometry of circular cylinder or oval cylinder. The plurality of pillars 125 herein are arranged at intervals narrow enough to prevent any target components in the sample from passing therethrough. Because a fluid such as buffer carrying the sample can pass through the gaps between the pillars 125, the gateway portion 210 can be made electro-conductive, and this allows the sample passing through the channel for separation 112 to move therethrough, without being electrically affected by the gateway portion 210 and so forth.

Although the above description is made on the gateway portions provided between the individual compartments of the channel for separation 112, it is also allowable to configure the channel for separation 112 as having no gateway portion provided thereto, or as having the gateway portions widened in the opening portion thereof. In this case, it is all enough that the entrance portions of the individual compartments are formed as being narrowed as compared with other region of the channel for separation 112, and that at least a part of the sample can be prevented from migrating towards the sample introduction portion.

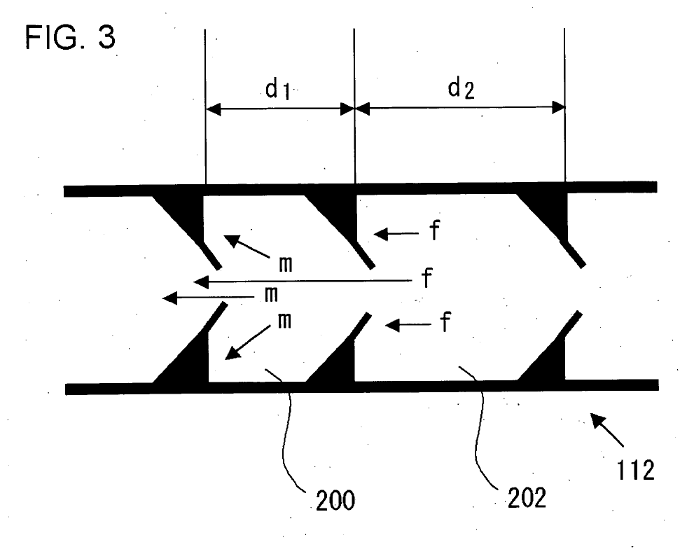

FIG. 3 is a drawing showing a part of such channel for separation 112. The compartment 200 and compartment 202 are shown in the drawing. In this configuration, wall portions partitioning the individual compartments are formed at the entrances of the individual compartments 200 and 202. This makes the entrance portions of the individual compartments 200 and compartment 202 narrower in the width as compared with other region of the channel for separation 112. The wall portions herein are preferably formed so that ratio of the sample passing therethrough becomes larger when the sample is allowed to flow towards the sample introduction port (leftward in the drawing), rather than towards the destination of recovery (rightward in the drawing).

Operations in an exemplary case where a sample containing a plurality of component f and m is introduced into the compartment 200 of the channel for separation 112 shown in FIG. 3 will be explained below. When the sample is introduced into the compartment 200, and voltage is applied so as to make the sample move rightward, the component f having a larger migration speed moves to as close as the center of the compartment 202, and the component m having a smaller migration speed stays in the compartment 200. The following description will be made only on the component for explanation. When the voltage is applied so as to make the sample move leftward, a part of component f having been kept staying in the compartment 202 flows back to the compartment 200 on the left side, but the migration is blocked by the wall portions provide between the compartment 200 and compartment 202, so that the part of the component f are remained staying in the compartment 202 and in the vicinity of the wall portions.

Next, the direction of voltage application is inverted so as to make the sample move rightward in the drawing. In this process, any portion, out of the component f, having flown back to the compartment 200 returns to the former position before the back flow (near the center of the compartment 202). Any portion, out of component f, having been staying in the vicinity of the wall portion of the compartment 202 moves ahead of the compartment 202, or to the next compartment rightward in the drawing. When the direction of voltage application is reversed again so as to make the sample move leftward, a part of the component f, having been moved near the center of the compartment 202 flows back to the compartment 202, and a part of the residue stays in the vicinity of the wall portion between the compartment 200 and compartment 202. As described in the above, repetition of cycles switching the direction of voltage application is successful in exponentially reducing ratio of back flow towards the initial compartment on the left hand side of the drawing, and the individual compartments will have components gathered therein depending on their lengths.

Because the individual components can be recovered after being gathered and concentrated in the channel for separation 112, the present embodiment makes it possible to obtain a sample used for analysis, and to raise accuracy of the analysis.

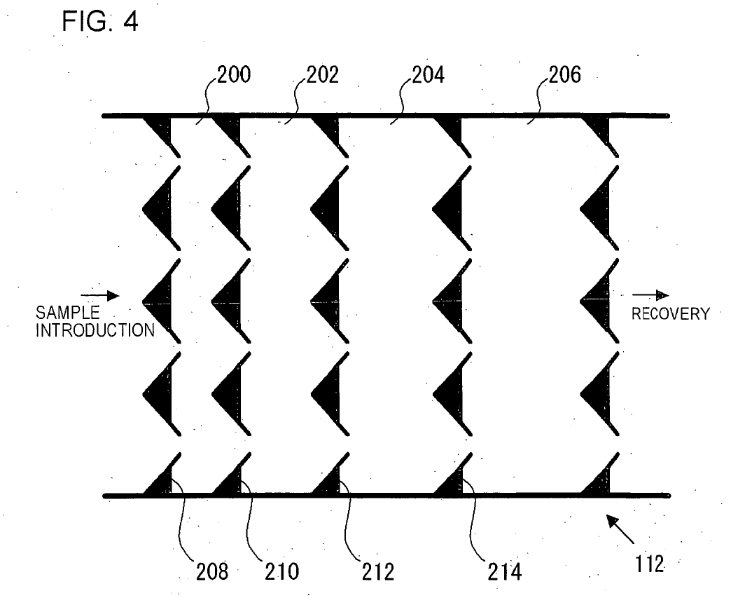

It is also allowable, as shown in FIG. 4, to configure the separation passageway as having a plurality of gateways between every adjacent compartments. In this case, the plurality of gateway portions 208 to 214 are disposed in parallel in the direction normal to the direction of sample flow. This makes it possible to separate a larger amount of sample in a rapid and accurate manner.

### Second Embodiment

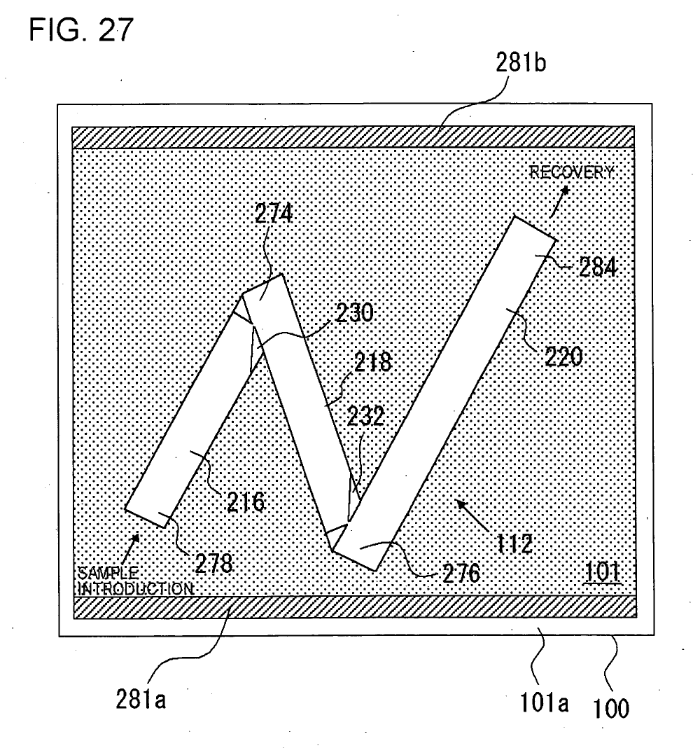

FIG. 27 is a top view showing a configuration of the separation apparatus 100 according to the second embodiment of the present invention. In this embodiment, the channel for separation 112 has a plurality of divisional channel 216, divisional channel 218 and divisional channel 220. The sample herein is introduced into the divisional channel 216, flows through the divisional channel 218 and the divisional channel 220, and is recovered. The divisional channel 216, the divisional channel 218 and the divisional channel 220 are formed so that the one placed closer to the destination of recovery has a larger length. That is, the divisional channel 220 is the longest, the divisional channel 218 is the second longest, and the divisional channel 216 is the shortest. The divisional channel 216 and the divisional channel 218 are formed as being bent at a branching point 274, and the divisional channel 218 and divisional channel 220 are formed as being bent at a branching point 276. The divisional channel 216 and the divisional channel 218 herein are formed substantially in parallel with each other.

A check valve 230 is provided between the divisional channel 216 and divisional channel 218, and a check valve 232 is provided between the divisional channel 218 and divisional channel 220. The check valve 230 is configured so as to prevent the components once reached the branching point 274 from flowing back towards the divisional channel 216 again. Similarly, the check valve 232 is configured so as to prevent the components once reached the branching point 276 from flowing back towards the divisional channel 218 again. Because ratio of components flowing back towards the sample introduction portion 278 can be reduced when the components reside at the branching point 274 and branching point 276, this configuration is successful in separate the components in the sample in an accurate and efficient manner.

The check valve 230 and the check valve 232 can be configured typically by the pillars 125 explained in the first embodiment. It is also allowable to form the check valve 230 and the check valve 232 by providing hydrophobic treatment to the surface of the hydrophilic channel for separation 112. The hydrophobic treatment can adopt a technique of forming a hydrophobic film on the surface of the channel for separation 112, using a silane compound such as silane coupling agent or silazane (e.g., hexamethyl silazane), typically by spin coating, spraying, dipping or vapor phase process. As the silane coupling agent, those having a hydrophobic group, such as thiol group or the like, can be used.

The hydrophobic treatment may be carried out also by printing techniques such as stamping and ink jet printing. The stamping employs PDMS (polydimethylsiloxane) resin. The PDMS resin is obtained by polymerizing silicone oil, and retains the silicone oil as being filled in the molecular gap thereof even after the resin formation. Bringing the PDMS resin into contact with the surface of the channel for separation 112 therefore results in water repellency due to a strong hydrophobicity exhibited at the contact portion. Making an effective use of this, the hydrophobic check valve 230 and check valve 232 can be formed by making contact with a PSMA block, used as a stamp, having recesses formed thereon at positions corresponding to the check valve 230 and check valve 232. In the ink jet process, use of a silicone oil as an ink for the ink jet printing is successful in forming the hydrophobic check valve 230 and check valve 232. Because the region subjected to the hydrophobic treatment does not allow the fluid to pass therethrough, the sample flow is inhibited. By making the check valve 230 as being tapered at the boundary with the divisional channel 218, so as to narrow the width of the divisional channel 216 in the direction approaching the divisional channel 218, it is made possible to move the sample from the divisional channel 216 to the divisional channel 218 in a relatively easy manner, and to prevent the sample from moving in the opposite direction.

On the upper side and lower side, in the drawing, of the substrate 101 of the separation apparatus 100, there is provided a first electrode 281a and a second electrode 281b. By switching the direction of voltage application to the electrodes 281a and 281b, it is made possible to move the components in the sample in the upper direction or lower direction within the divisional channels 216, 218, 220. Also in this embodiment, similarly to as explained in the first embodiment referring to FIG. 18, the first electrode 281a and the second electrode 281b are connected to a power source and a power source control unit, and patterns of voltage applied to the first electrode 281a and the second electrode 281b are controlled by the power source control unit. The substrate of the separation apparatus 100 herein may have a side wall 101a formed thereon, and the portion other than the region where the divisional channel 216, the divisional channel 218 and the divisional channel 220 are formed may have, for example, the pillars 125 explained in the first embodiment formed thereon. The pillars 125 are arranged at intervals narrow enough to prevent any components-to-be-separated in the sample from passing therethrough. The configuration is not limited to those having the pillars 125 arranged therein, but also may be those in which the channel for separation 112 is partitioned by filters or the like, wherein any configurations are allowable provided that the channel for separation 112 are configured so as to avoid leakage of the components-to-be-separated therefrom, and so as to allow buffer or the like to flow therethrough and so as to allow current to conduct therethrough. When the surface of the substrate 101 is filled with a buffer or the like in this state, application of voltage between the first electrode 281a and the second electrode 281b can make the sample migrate in the upper direction and lower direction, in the drawing, within the individual divisional channel 216, divisional channel 218 and divisional channel 220.

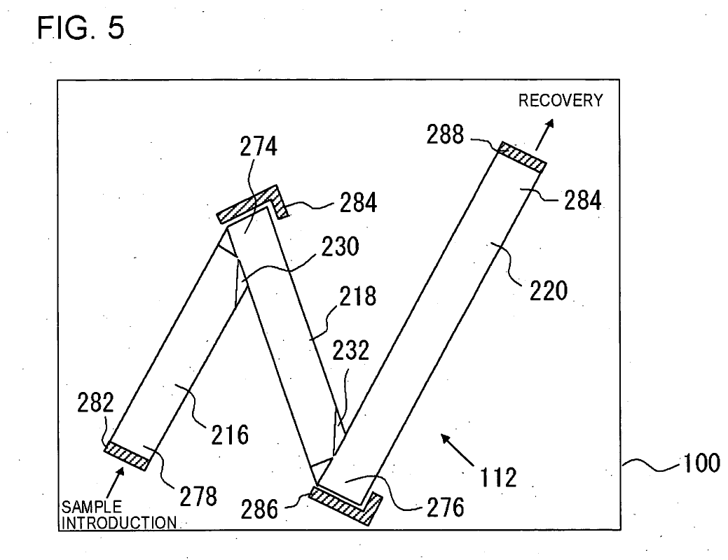

In this embodiment, the separation apparatus 100 may be configured as shown in FIG. 5. In this case, an electrode 282, an electrode 284, an electrode 286 and an electrode 288 are provided to both ends of the individual divisional channels 216, 218, and 220. By switching the direction of voltage application to the individual electrodes 284 to 288, it is made possible to move the components in the sample in the upper direction or lower direction, in the drawing, within the divisional channels 216, 218, and 220. Also in this case, the individual electrodes 284 to 288 are connected to a power source and a power source control unit, and patterns of voltage applied to the individual electrodes 284 to 288 are controlled by the power source control unit. Control is made by the power source control unit so as to equalize voltage to be applied to each of the divisional channels 216 to 220. Intensity of electric field depends on potential between the electrodes and distance between the electrode, so that in an exemplary case of the separation apparatus 100 of this embodiment having the divisional channels 216, 218, 220 differed in their lengths, the power source control unit applies voltage so that the divisional channels 216, 218, and 220 will have different potential values. This embodiment has described a case where the individual divisional channels 216 to 220 are differed in their lengths, but the configuration shown in FIG. 5 makes it possible to obtain similar effects even if the lengths of the divisional channels 216 to 220 are remained constant, by applying voltage so as to differ voltage values appeared on the individual divisional channels.

The electrodes 282 to 288 can be formed typically by the process described below.

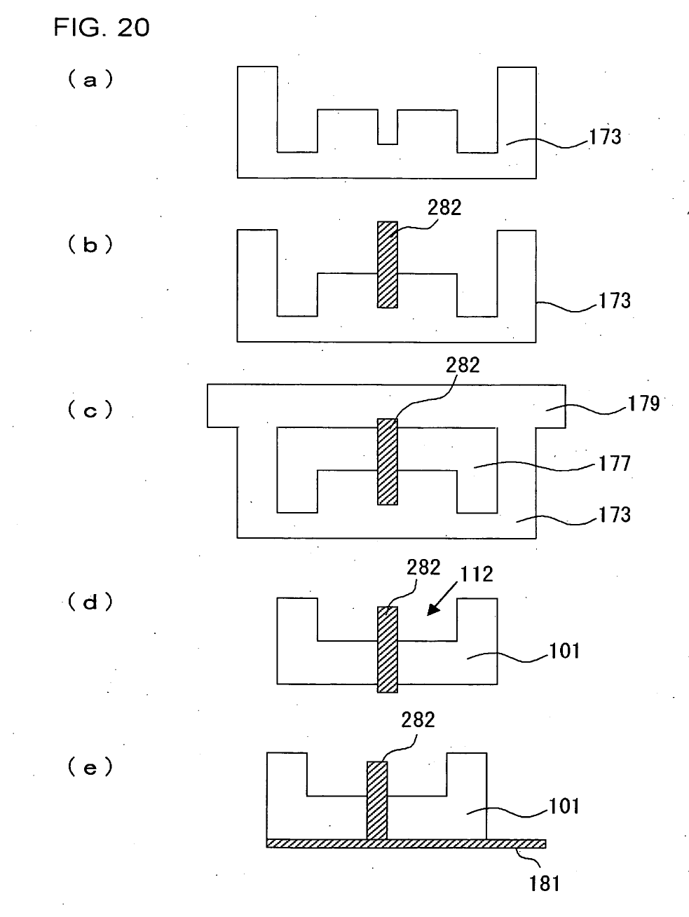

FIG. 20 is a drawing showing process steps of manufacturing the electrode 282. Other electrodes 284 to 288 can similarly be formed in this process.

First, a die 173 having an attachment portion for the electrode 282 is prepared (FIG. 20(a)). Next, the electrode 282 is placed in the die 173 (FIG. 20(b)). Examples of materials composing the electrode 282 include Au, Pt, Ag, Al, Cu and so forth. A cover die 179 is then set on the die 173 so as to immobilize the electrode 282, a resin 177 forming the substrate 101 is injected into the die 173 and molded (FIG. 20(c)). The resin 177 applicable herein is PMMA, for example.

Thus-formed resin 177 is released from the die 173 and the cover die 179, and thereby the substrate 101 having the channel for separation 112 formed thereon is obtained (FIG. 20(d)). Impurities on the surface of the electrode 282 are removed by ashing, to thereby expose the electrode 282 in the back surface of the substrate 101. Next, a metal film is formed by evaporation or the like on the back surface of the substrate 101, to thereby form a wiring 181 (FIG. 20(e)) In this way, the electrode 282 can be provided to the channel for selection 112. Thus-formed electrode 282 or wiring 181 is designed to be connected to an external power source (not shown), to thereby allow voltage application.

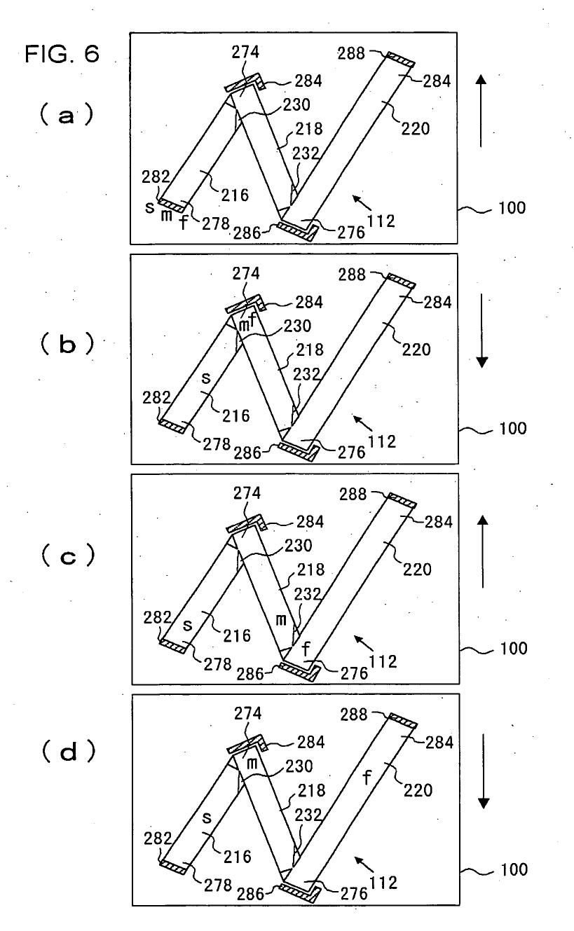

Next, making a reference on the separation apparatus 100 configured as shown in FIG. 5, operations which proceed when a sample is introduced into the channel for separation 112 will be explained referring to FIG. 6 to FIG. 8. Same operations will proceed also for the separation apparatus 100 configured as shown in FIG. 27.

First, as shown in FIG. 6(a) a sample containing three components f, m and s is introduced into the divisional channel 216, and voltage is applied so as to make the sample flow upward (direction indicated by the arrow) in the drawing. This makes the individual components f, m and s move upward, in the drawing, at their specific speeds. It is assumed herein that the component f flows fastest, component m flows second fastest, and component s flows slowest.

After being applied with the voltage for a predetermined duration of time, the components f having the fastest migration speed, and then the component m having the second fastest migration speed move to the branching point 274. The voltage herein is applied while keeping the duration time constant, during which the component f moves over a distance longer than the divisional channel 218. The component s at this time is still under migration through the divisional channel 216.

Thereafter, direction of voltage application is inverted, and the voltage is applied so as to make the sample flow downward in the drawing. This makes the components f and m move downward, in the drawing, within the divisional channel 218, and makes the component s move downward in the drawing within the divisional channel 216. After being applied with the voltage for a predetermined duration of time, the component f reaches the branching point 276, as shown in FIG. 6(c). The component m at this time is still under migration through the divisional channel 218. The component s flows back through the divisional channel 216, and moves to the sample introduction portion 278.

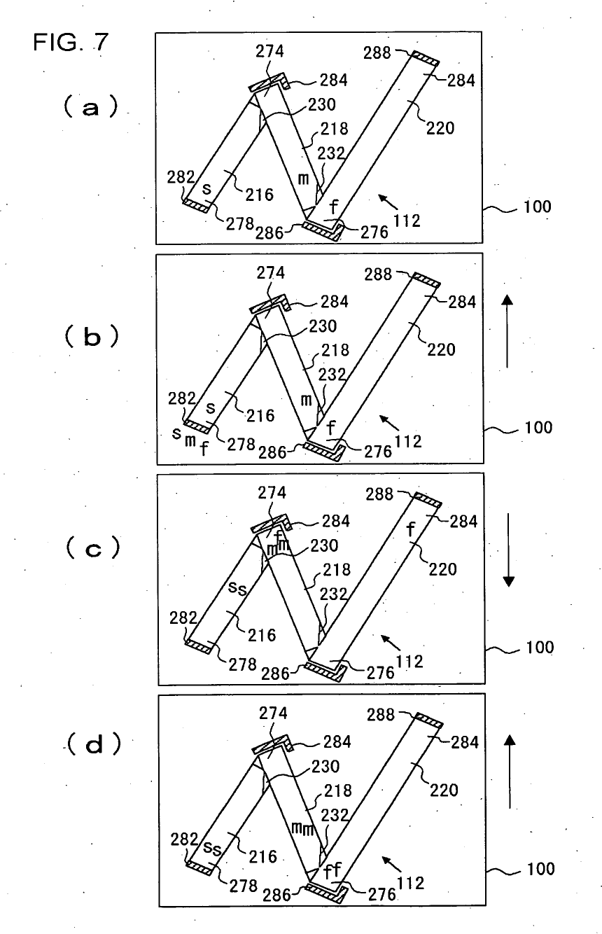

In this state, direction of voltage application is inverted again, and the voltage is applied so as to make the sample flow upward. After being applied with the voltage for a predetermined duration of time, the component f having the large migration speed moves through the divisional channel 220, as shown in FIG. 6(d). The component m at this time flows back through the divisional channel 218 to reach the branching point 274. The component s moves through the divisional channel 216. In this state, direction of voltage application is inverted again, and the voltage is applied so as to make the sample flow downward. The component f then moves to the branching point 276, as shown in FIG. 7(a), and the component m moves downward within the divisional channel 218. The component s at this time again reaches the sample introduction portion 278 of the divisional channel 216.

Next, as shown in FIG. 7(b), a new lot of sample is introduced into the divisional channel 216, and the voltage is applied so as to make the sample flow upward. After being applied with the voltage for a predetermined duration of time, the components are separated as shown in FIG. 7(c). Next, direction of voltage application is inverted again, so as to make the sample flow downward. After being applied with the voltage for a predetermined duration of time, as shown in FIG. 7(d), the component fin the initially-introduced sample and the component f in the later-introduced sample move together to the branching point 276, the components m are gathered midway in the divisional channel 218, and the components s are gathered at the end portion of the divisional channel 216.

Similar procedures are repeated thereafter. In this process, any components having migration ranges under voltage application for a predetermined duration of time shorter than the length of the divisional channel 216 remain forever in the divisional channel 216, and cannot move to the next divisional channel 218. Similarly, any components having migration ranges under voltage application for a predetermined duration of time shorter than the length of the divisional channel 218 remain unmoved forever in the divisional channel 218, and any components having migration ranges under voltage application for a predetermined duration of time shorter than the length of the divisional channel 220 remain unmoved forever in the divisional channel 220.

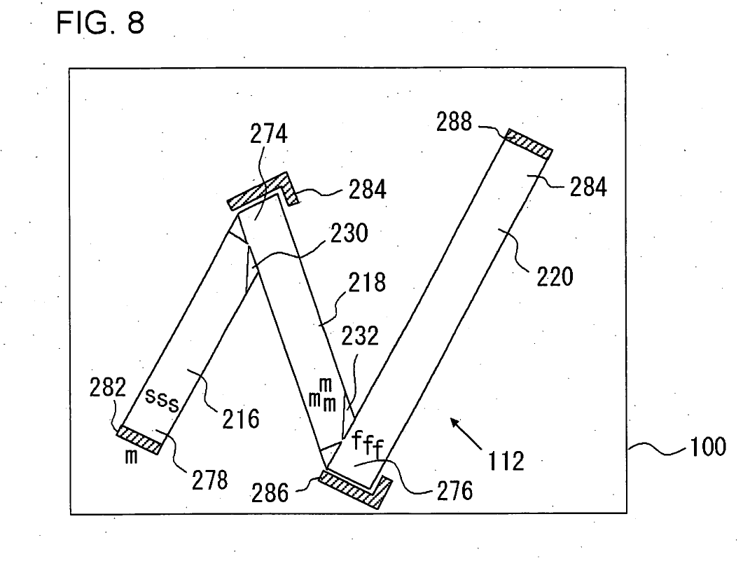

By repeating the process cycle in which the voltage is applied for a predetermined duration of time so as to move the sample alternately upward and downward in the drawing as described in the above, a plurality of components contained in the sample can be separated into the individual divisional channels depending on their specific migration ranges. It is therefore made possible to separate the individual components in a concentrated manner by adding, on occasion, the sample to the sample introduction portion 278 and carrying out the process cycle, because the individual components can be separated into the individual divisional channels depending on their specific migration ranges. This result in states as shown in FIG. 8, in which the components s are gathered and concentrated in the divisional channel 216, the components m are gathered and concentrated in the divisional channel 218, and the components f are gathered and concentrated in the divisional channel 220.

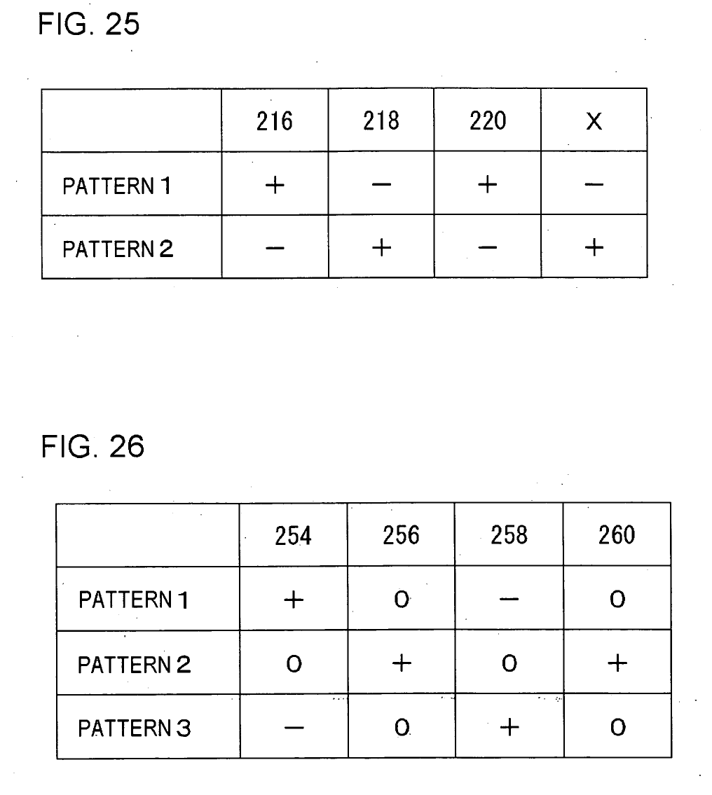

FIG. 25 is a chart showing application patterns of voltage to be applied, in this embodiment by the power source control unit, to the individual divisional channels 216 to 220. Although the channel for separation 112 in the above embodiment has been describe as containing three divisional channels, it is also allowable to provide a larger number of divisional channels. The next paragraphs will describe an exemplary case having an additional divisional channel X provided next to the divisional channel 220, in addition to the divisional channel 216, the divisional channel 218, and the divisional channel 220. In the chart, “+” indicates voltage application causing sample migration in the forward direction of the channel for separation 112 (direction approaching the recovery unit), and “−” indicates voltage application causing sample migration in the opposite direction.

As shown in the chart, the current control unit first executes pattern 1 in which “+” voltage is applied to the divisional channel 216 and the divisional channel 218, and “−” voltage is applied to the divisional channel 218 and the divisional channel X. Next, the power source control unit executes pattern 2 in which “−” voltage is applied to the divisional channel 216 and the divisional channel 218, and “+” voltage is applied to the divisional channel 218 and the divisional channel X. The power source control unit repeats the same processes thereafter.

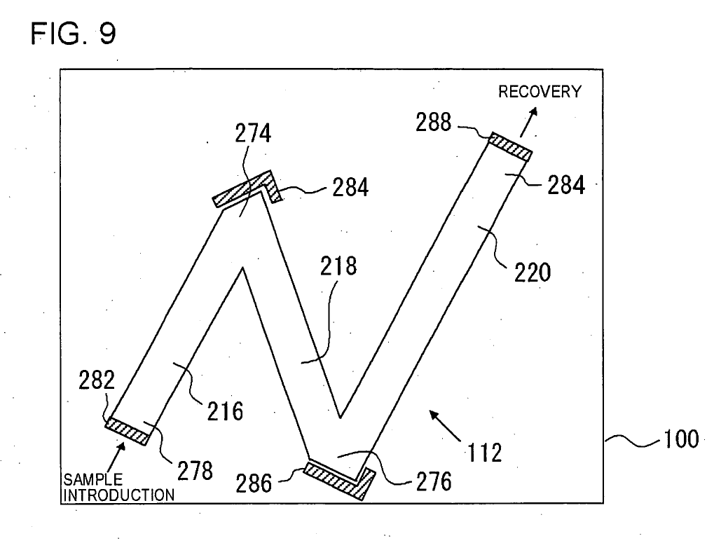

FIG. 9 is a drawing showing a modified example of the separation apparatus 100 shown in FIG. 5. The separation apparatus 100 shown in FIG. 5 was explained as having the check valve 230 and the check valve 232 provided to the channel for separation 112, whereas a configuration omitting them is also allowable.

In this configuration, if the voltage is applied, for example, so as to make the sample flow downward when a component resides at the branching point 274, the component which resides at the branching point 274 flows into the divisional channel 218, but at the same time also into the divisional channel 216. Sequential addition of the sample from the sample introduction portion 278 and repetition of the voltage application cycle, however, allows the components having the same migration rate to combine with each other within the same divisional channel, so that it is made possible to separate the individual components in a concentrated manner.

The individual divisional channels 216 to 220 herein are preferably formed so that a larger ratio of the components, which have reached the branching point 274 and the branching point 276, is directed to the direction approaching the recovery end. This makes it possible to accurately separate the components, even with a reduced number of times of the voltage application cycles.

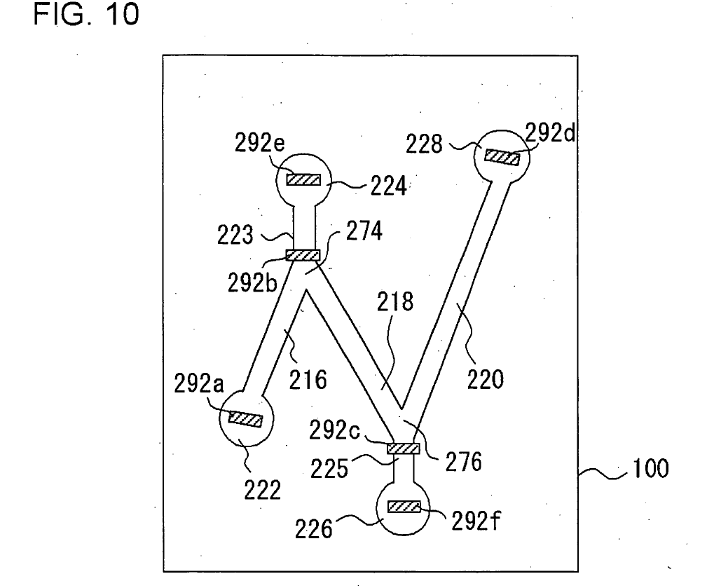

The individual components separated by the separation apparatus 100 of this embodiment can sequentially be taken out from the end portion 284 of the channel for separation 112, by gradually elongating the duration of time of voltage application, but the components can be taken out also from the branching point 274 and the branching point 276. FIG. 10 is a drawing showing an example in which sample recovery units are provided to the branching point 274 and the branching point 276. The separation apparatus 100 includes a recovery-use channel 223 provided to the branching point 274, a recovery-use channel 225 provided to the branching point 276, a sample introduction portion 222, a sample recovery unit 224, a sample recovery unit 226, and a sample recovery unit 228. The sample introduction portion 222, the branching point 274, the branching point 276, the sample recovery unit 228, the sample recovery unit 224 and the sample recovery unit 226 have, provided thereto, an electrode 292a, an electrode 292b, an electrode 292c, an electrode 292d, an electrode 292e and an electrode 292f, respectively.

Next paragraphs will explain a method of separating and recovering components in a sample using thus-configured separation apparatus 100. The explanation herein will be made on an exemplary case in which negatively-charged substances, such as DNA, are separated.

First, the sample is introduced into the sample introduction portion 222, and the voltage is applied so as to make potential of electrode 292b higher than those of the electrode 292a and electrode 292c, and so as to make potential of the electrode 292d higher than that of the electrode 292c. This makes the sample flow upward in the drawing. The electrode 292e and the electrode 292f herein are set lower in the potential than the electrode 292b and electrode 292c, respectively. This makes the sample introduced into the sample introduction portion 222 flow towards the branching point 274, wherein any components having large migration speeds reach the branching point 274. Because the potential of the electrode 292b at this time is set higher than that of the electrode 292e, it is made possible to prevent the components which have reached the branching point 274 from flowing into the recovery-use channel 223, if the components are charged negative.

Next, the voltage is applied so as to make potential of the electrode 292b lower than those of the electrode 292a and electrode 292c, and so as to make the potential of the electrode 292d lower than that of the electrode 292c. The electrode 292e and electrode 292f herein are set lower in the potential than the electrode 292b and electrode 292c, respectively. This makes the components which have stayed in the divisional channel 218 move to the divisional channel 218, wherein any components having larger migration speeds reach the branching point 276. Because the potential of the electrode 292c at this time is set higher than that of the electrode 292f, it is made possible to prevent the components which have reached the branching point 276 from flowing into the recovery-use channel 223, if the components are charged negative.

By repeating the voltage application cycles as described in the above, the individual components are gathered in either of the branching points 274 and 276, depending on their specific migration ranges. When the components are recovered from the branching points 274 or 276, the voltage is applied so as to make the potential of the electrode 292e and the electrode 292f higher than those of the electrode 292b and the electrode 292c, respectively. This makes it possible to recover the component which have stayed at the branching point 274, and the component which have stayed at the branching point 276 can be recovered into the sample recovery unit 224 and the sample recovery unit 226, respectively.

### Third Embodiment

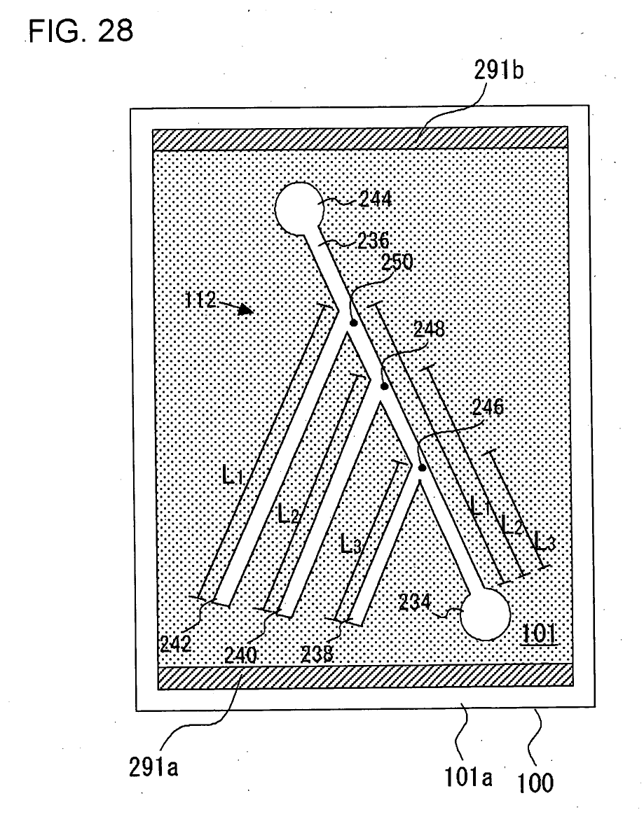

FIG. 28 is a top view showing a configuration of the separation apparatus 100 according to the third embodiment of the present invention. In this embodiment, the channel for separation 112 includes a main channel 236, a divisional channel 238, a divisional channel 240, a divisional channel 242, a sample introduction portion 234, and a sample recovery unit 244. Here, the divisional channel 238 is formed so as to have length L₃, the divisional channel 240 is formed so as to have length L₂, and the divisional channel 242 is formed so as to have length L₁. The divisional channel 238 branches out from the main channel 236 at the branching point 246 distant by L₃ from the sample introduction portion 234, the divisional channel 240 branches out from the main channel 236 at the branching point 248 distant by L₂ from the sample introduction portion 234, and the divisional channel 242 branches out from the main channel 236 at the branching point 250 distant by L₁ from the sample introduction portion 234. In addition, the divisional channel 238, the divisional channel 240, and the divisional channel 242 are formed at a predetermined angle away from the main channel 236, and the divisional channel 238, the divisional channel 240, and the divisional channel 242 are formed in parallel with each other.

On the lower side and the upper side of the substrate 101 of the separation apparatus 100, there are provided a first electrode 291a and a second electrode 290b, respectively. By switching the direction of voltage application to the first electrode 290a and the second electrode 290b, it is made possible to move the components in the sample in the upper direction or lower direction, in the drawing, within the main channel 236, the divisional channel 238, the divisional channel 240, and the divisional channel 242. Also in this embodiment, similarly to as explained in the first embodiment referring to FIG. 18, the first electrode 291a and the second electrode 291b are connected to a power source and a power source control unit, and the patterns of voltage applied to the first electrodes 291a and the second electrode 291b are controlled by the power source control unit. Also in this case, the substrate 101 has a side wall 101a formed thereon similarly to as described in the second embodiment, and the portion other than the region where the channel 112 is formed has, for example, the pillars 125 formed thereon, configured so as to prevent any components-to-be-separated passing therethrough. When the surface of the substrate 101 is filled with a buffer or the like in this state, application of voltage between the first electrode 291a and the second electrode 291b can make the sample migrate upward and downward, in the drawing, within the channel 112.

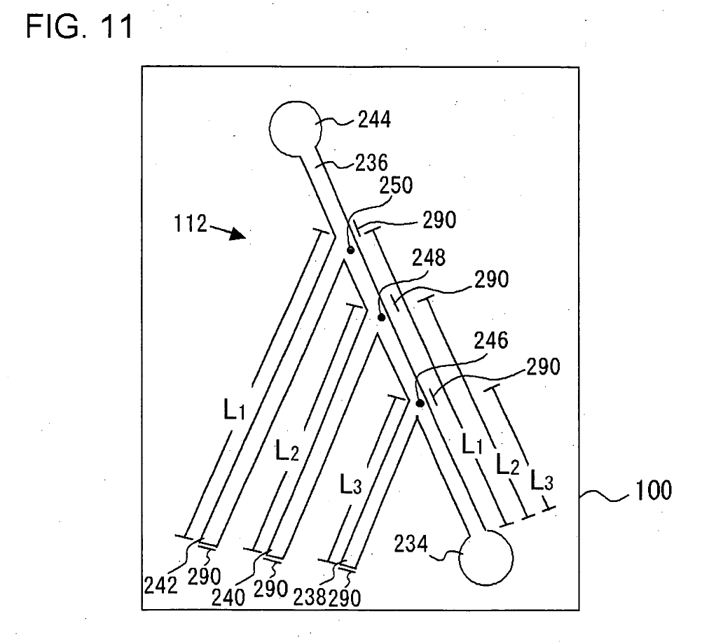

In this embodiment, the separation apparatus 100 can be configured also as shown in FIG. 11. In this configuration, each of the divisional channel 238 to the divisional channel 242 has electrodes 290 provided on both ends thereof. Although not illustrated in the drawing, the electrodes are also provided to the sample introduction portion 234 and the sample recovery unit 244. Also in this case, the individual electrodes 290, and the electrodes provided to the sample introduction portion 234 and the sample recovery unit 244 are connected to a power source and a power source control unit, and patterns of voltage applied to the individual electrodes are controlled by the power source control unit. Control is made by the power source control unit so as to equalize voltage to be applied to the main channel 236, the divisional channel 238, the divisional channel 240, and the divisional channel 242.

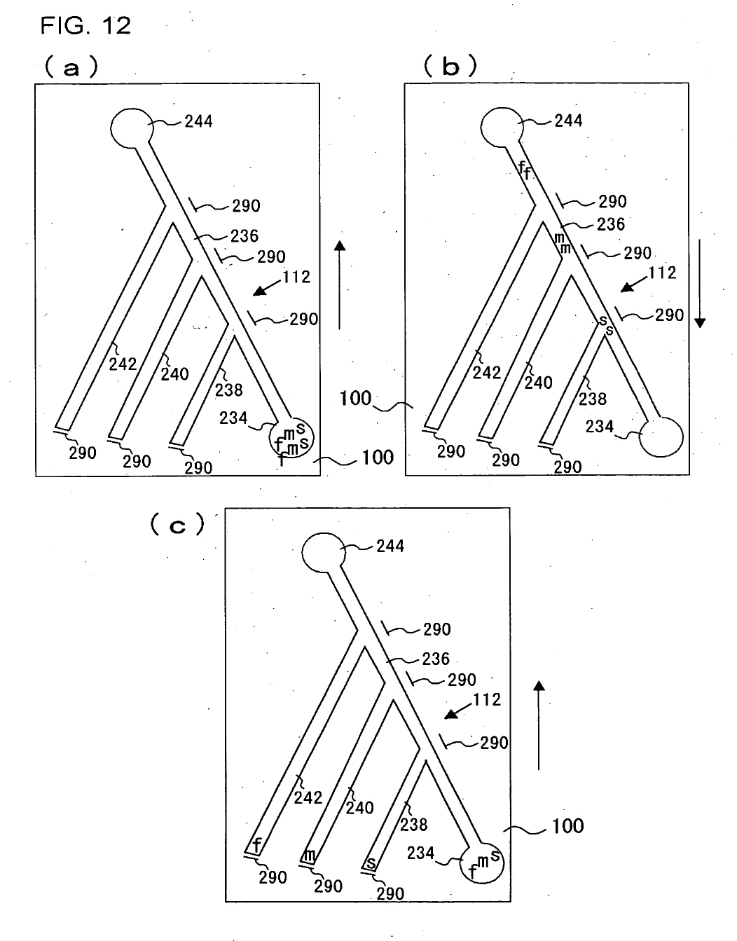

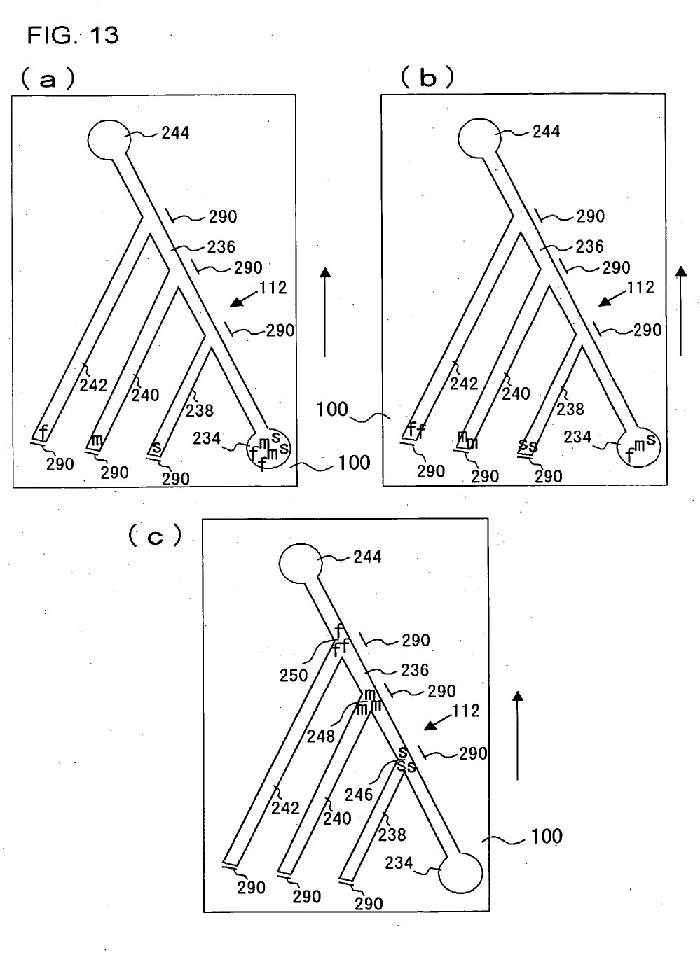

Next, making a reference on the separation apparatus 100 configured as shown in FIG. 11, operations which proceed when a sample is introduced into the channel for separation 112 will be explained referring to FIG. 12 and FIG. 13. Same operations will proceed also for the separation apparatus 100 configured as shown in FIG. 28.

First, as shown in FIG. 12(a) a sample containing three components f, m and s is introduced into the sample introduction portion 234. Next, the voltage is applied so as to make the sample flow upward (direction indicated by the arrow) in the drawing. This makes the individual components f, m and s move upward, in the drawing, at their specific speeds. It is assumed herein that the component f flows fastest, the component m flows second fastest, and the component s flows slowest.

After being applied with the voltage for a predetermined duration of time, as shown in FIG. 12(b), the individual components f, m and s are separated. Next, direction of voltage application is inverted, and the voltage is applied so as to make the sample flow downward in the drawing. This makes the individual components f, m and s move within the main channel 236, from the direction of the sample recovery unit 244 towards the sample introduction portion 233. The component f, which resides on the sample recovery unit 244 side as viewed from the branching point 250 (FIG. 11), moves into the divisional channel 242 to a certain extent of ratio, when it passes the branching point 250. Also at this time, the component m, which resides between the branching point 250 and the branching point 248 (FIG. 11), moves into the divisional channel 240 to a certain extent of ratio, when it passes the branching point 248. Similarly, the component s, which resides between the branching point 248 and the branching point 246 (FIG. 11), moves into the divisional channel 238 to a certain extent of ratio, when it passes the branching point 246. Voltage application so as to make the sample flow downward results in, as shown in FIG. 12(c), migration of the component f, component m and component s to the end portions of divisional channel 242, divisional channel 240, and divisional channel 238, respectively, and portions of these components flow back to the sample introduction portion 234. In this process, every time, the duration of time over which the voltage is applied so as to make the sample flow downward is set longer than the duration of time over which the voltage is applied so as to make the sample flow upward, so that the substances which reside in the channel can reach and stay around the electrodes 290 when the sample is allowed to flow downward in the drawing.

Next, as shown in FIG. 13(a), the sample is added to the sample introduction portion 234, and the voltage is applied so as to make the sample flow upward in the drawing (direction indicated by the arrow). After being applied with the voltage in this direction for a predetermined duration of time, direction of voltage application is inverted again, and the voltage is applied for a predetermined duration of time. Repetition of these processes results in, as shown in FIG. 13(b), gradual increase in amounts of the individual components move to the end portions of the divisional channel 238, the divisional channel 240 and the divisional channel 24.

When the voltage is further applied thereafter so as to make the sample flow upward in the drawing, any components having the same migration range, such as those having been staying at the end portions of the divisional channel 238, the divisional channel 240 and the divisional channel 242, and such as those having been staying in the sample introduction portion 234, are brought into confluence and gathered to the branching point 246, the branching point 248, and the branching point 250, respectively, as shown in FIG. 13(c). Voltage application while keeping this state is successful in sequentially taking thus-gathered individual components out from the sample recovery unit 244. As is clear from the above, in this embodiment, it is made possible to recover the components in the sample newly added from the sample introduction portion, together with the components having preliminarily been separated into the individual divisional channels, by adjusting the lengths of the individual divisional channels branched out from the main channel equal to those of portions ranging from the sample introduction portion to the corresponded branching points. As has been described in the above, the separation apparatus 100 of this embodiment is successful in separating the components in the sample in a concentrated manner.

It is to be noted herein, although not shown, that the apparatus may be configured so as to collect the individual components from the end portions of the divisional channel 238, the divisional channel 240, and the divisional channel 242.

### Fourth Embodiment

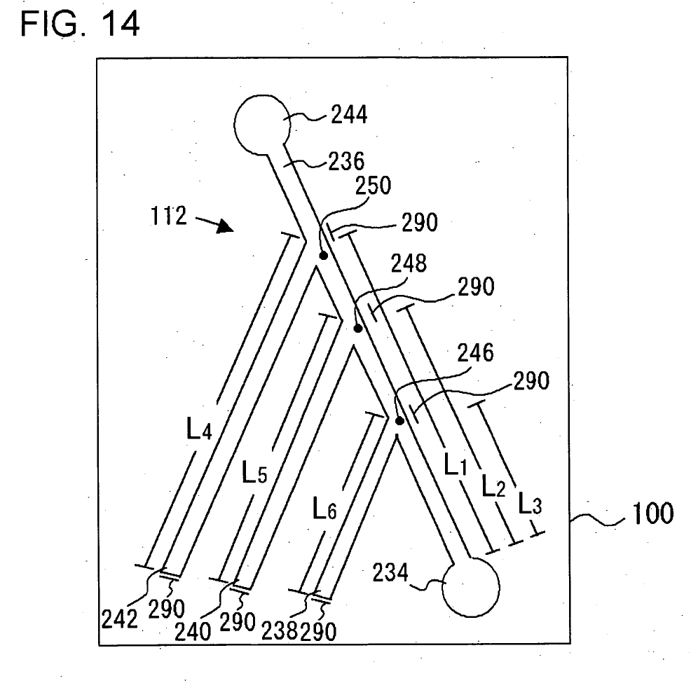

FIG. 14 is a top view showing a configuration of the separation apparatus 100 according to the fourth embodiment of the present invention. Also in this embodiment, similarly to as described in the third embodiment referring to FIG. 11, the channel for separation 112 includes the main channel 236, the divisional channel 238, the divisional channel 240, the divisional channel 242, the sample introduction portion 234, and the sample recovery unit 244. In this embodiment, the divisional channel 238 branches out from the main channel 236 at the branching point 246 distant by L₃ from the sample introduction portion 234, the divisional channel 240 branches out from the main channel 236 at the branching point 248 distant by L₂ from the sample introduction portion 234, and the divisional channel 242 branches out from the main channel 236 at the branching point 250 distant by L₁ from the sample introduction portion 234. The divisional channel 238 is formed with length L₆, the divisional channel 240 is formed with length L₅, and the divisional channel 242 is formed with length L₄. In this embodiment, the divisional channel 238 is formed longer than the distance from the sample introduction portion 234 to the branching point 246, the divisional channel 240 is formed longer than the distance from the sample introduction portion 234 to the branching point 248, and the divisional channel 242 is formed longer than the distance from the sample introduction portion 234 to the branching point 250. It means that L₆>L₃, L₅>L₂ and L₄>L₁.

The sample containing a plurality of components is introduced from the sample introduction portion 234 of thus-configured channel for separation 112, and the voltage application cycles are repeated, similarly to as described in the third embodiment. In this process, every time, the duration of time over which the voltage is applied so as to make the sample flow downward is set longer than the duration of time over which the voltage is applied so as to make the sample flow upward. This makes the samples, which have respectively moved to the divisional channel 238, the divisional channel 240 and the divisional channel 242, reach the end portions of the divisional channel 238, the divisional channel 240 and the divisional channel 242, but never makes them reach the branching point 246, the branching point 248 and the branching point 250, respectively, even then the voltage is applied so as to make the sample flow upward. This is successful in preventing the components, once moved into the divisional channel 238, the divisional channel 240 and the divisional channel 242, from flowing back to the sample introduction portion 234.

Also in this embodiment, by applying voltage so as to make the sample move upward, after the components are moved to the divisional channel 238, the divisional channel 240 and the divisional channel 242, it is made possible to sequentially take the gathered individual components out from the sample recovery unit 244. As described in the above, the separation apparatus 100 according to the present embodiment is successful in separating the components in the sample in a concentrated manner. Although not illustrated in the drawing, it is also allowable to configure the apparatus so as to recover the individual components form the end portions of the divisional channel 238, the divisional channel 240 and the divisional channel 242.

Also in this embodiment, it is, of course, still also allowable to provide the electrodes 291a and 291b on the upper side and lower side, in the drawing, of the substrate 101 as described in the third embodiment referring to FIG. 28.

### Fifth Embodiment

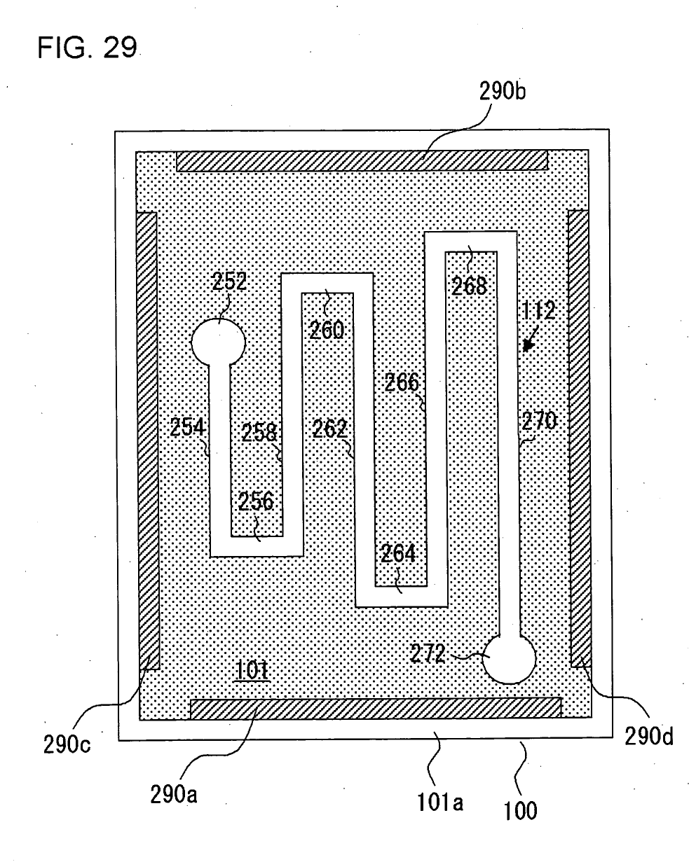

FIG. 29 is a top view showing a configuration of the separation apparatus 100 according to the fifth embodiment of the present invention. The separation apparatus 100 of this embodiment has the channel for separation 112, a sample introduction portion 252, and a sample recovery unit 272. The channel for separation 112 has a plurality of divisional channels 254, 258, 262, 266 and 270. The channel for separation 112 includes a connection channel 256 connecting the divisional channel 254 and the divisional channel 258, a connection channel 260 connecting the divisional channel 258 and the divisional channel 262, a connection channel 264 connecting the divisional channel 262 and the divisional channel 266, and a connection channel 268 connecting the divisional channel 266 and the divisional channel 270. The divisional channels 254, 258, 262, 266 and 270 are formed so that the one placed closer to the sample recovery unit 272 has a larger length. It means that the length of the divisional channel 254<the length of the divisional channel 258<the length of the divisional channel 262<the length of the divisional channel 266<the length of divisional channel 270.

On the lower side and the upper side, and on the left side and right side, in the drawing, of the substrate 101 of the separation apparatus 100, there are provided a first electrode 290a, a second electrode 290b, a third electrode 290c and a fourth electrode 290d, respectively. By switching the direction of voltage application to the first electrode 290a and the second electrode 290b, it is made possible to move the components in the sample in the upper direction or lower direction, in the drawing, within the channel 112. By applying voltage alto to the third electrode 290c and the fourth electrode 290d, it is made possible to move the components in the sample rightward, in the drawing, within the channel 112. Also in this embodiment, similarly to as described in the first embodiment referring to FIG. 18, the individual electrodes 290a to 290d are connected to a power source and a power source control unit, and patterns of voltage applied to the individual electrodes 290a to 290d are controlled by the power source control unit. Also in this case, the substrate 101 has a side wall 101a formed thereon similarly to as described in the second embodiment, and the portion other than the region where the channel 112 is formed has, for example, the pillars 125 formed thereon, configured so as to prevent any components-to-be-separated passing therethrough. When the surface of the substrate 101 is filled with a buffer or the like in this state, application of voltage between the first electrode 290a and the second electrode 290b, and between the third electrode 290c and the fourth electrode 290d can make the sample migrate upward, downward and rightward, in the drawing, within the channel 112.

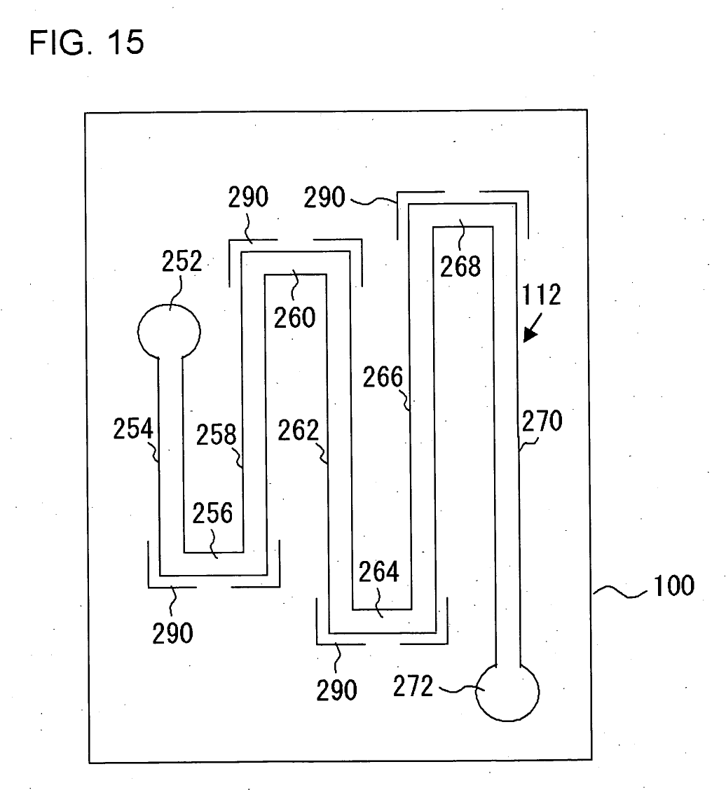

In this embodiment, the separation apparatus 100 may also be configured as shown in FIG. 15. In this configuration, an electrode is provided to each of the bent portions where the divisional channel 254, the connection channel 256, the divisional channel 258, the connection channel 260, the divisional channel 262, the connection channel 264, the divisional channel 266, the connection channel 268 and the divisional channel 270 are respectively connected. Although not illustrated in the drawing, the electrodes are also provided to the sample introduction portion 252 and the sample recovery unit 272. Also in this case, the individual electrodes 290, and the electrodes provided to the sample introduction portion 252 and the sample recovery unit 272 are connected to a power source and a power source control unit, and patterns of voltage applied to the individual electrodes are controlled by the power source control unit. Control is made by the power source control unit so as to equalize voltage to be applied to each of the divisional channels 254, 258, 262, 266 and 270.

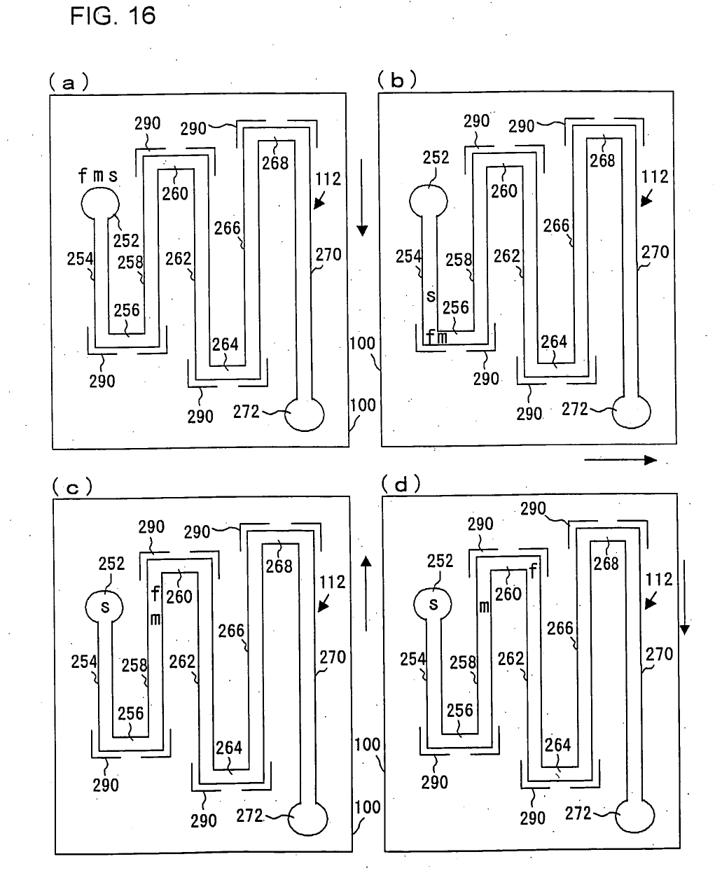

Next, making a reference on the separation apparatus 100 configured as shown in FIG. 15, operations which proceed when a sample is introduced into the channel for separation 112 will be explained referring to FIG. 16. Same operations will proceed also for the separation apparatus 100 configured as shown in FIG. 29.

First, as shown in FIG. 16(a) a sample containing three components f, m and s is introduced into the sample introduction unit 252, and voltage is applied so as to make the sample flow downward (direction indicated by the arrow) in the drawing. This makes the individual components f, m and s move downward, in the drawing, at their specific speeds. It is assumed herein that the component f flows fastest, component m flows second fastest, and components flows slowest.

After being applied with the voltage for a predetermined duration of time, the components f and m having larger migration speeds move to the boundary between the divisional channel 254 and the connection channel 256 as shown in FIG. 16(b). The component s at this time is still under migration through the divisional channel 254.

Thereafter, direction of voltage application is changed, and the voltage is adjusted so as to allow the sample to flow rightward in the drawing. This makes the components f and m move rightward within the connection channel 256, and reach the boundary between the connection channel 256 and the divisional channel 258. On the other hand, the component s does not move.

Next, direction of voltage application is changed again, and the voltage is adjusted so as to allow the sample to flow upward in the drawing. This makes the components f and m move through the divisional channel 258 towards the connection channel 260, as shown in FIG. 16(c). On the other hand, the component s moves through the divisional channel 254 towards the sample introduction portion 252.

Upon arrival of the component f at the boundary between the divisional channel 258 and the connection channel 260, direction of voltage application is changed again, and the voltage is adjusted so as to allow the sample to flow rightward in the drawing. This makes the component f move to the boundary between the connection channel 260 and the divisional channel 26, as shown in FIG. 16(d). The component m and the component s do not move at this time.

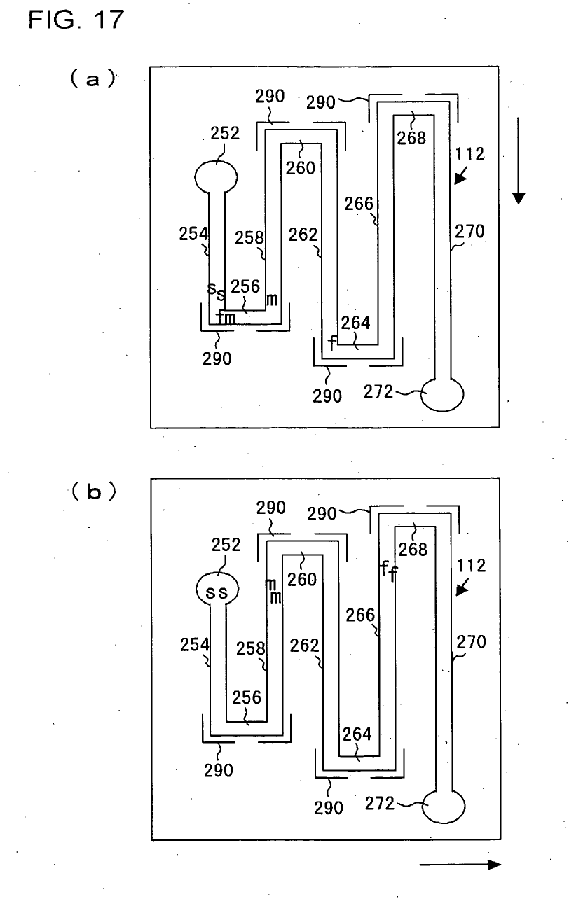

Next, direction of voltage application is changed again, and the voltage is adjusted so as to allow the sample to flow downward in the drawing. This makes the component f flow downward through the divisional channel 262, the component m flow downward through the divisional channel 258, and the component s flow downward through the divisional channel 254. When the next sample is introduced into the sample introduction portion 252, the individual components move downward, in the drawing, through the divisional channel 254 at their specific migration speeds. As a consequence, the individual components are separated as shown in FIG. 17(a). By repeating the similar voltage application cycles thereafter, the individual components are gathered in any of the divisional channels, depending on their migration ranges within a predetermined period of time, as shown in FIG. 17(b).

FIG. 26 is a chart showing application patterns of voltage to be applied, in this embodiment by the power source control unit, to the divisional channel 254, the connection channel 256, the divisional channel 258, and the connection channel 260. In the chart, “+” indicates voltage application causing sample migration in the forward direction of the channel for separation 112 (direction approaching the sample recovery unit 272), and “−” indicates voltage application causing sample migration in the opposite direction. Voltage application not causative of sample migration is indicated by “0”.

As shown in the chart, the current control unit first executes pattern 1 in which “+” voltage is applied to the divisional channel 254, and “−” voltage is applied to the divisional channel 258, while remaining the connection channel 256 and the connection channel 260 at “0”. Next, the power source control unit executes pattern 2 in which “+” voltage is applied to the connection channel 256 and the connection channel 260, while remaining the divisional channel 254 and the divisional channel 258 at “0”. Thereafter, the current control unit executes pattern 3 in which “+” voltage is applied to the divisional channel 258, and “−” voltage is applied to the divisional channel 254, while remaining the connection channel 256 and the connection channel 260 at “0”. The power source control unit thereafter repeats similar processes.

In this embodiment, all of the components which reached the end portions of the individual divisional channels are moved to the next divisional channels, without causing back flow of the components, so that it is made possible to efficiently separate and concentrate the individual components, even with a reduced number of times of the voltage application cycles.

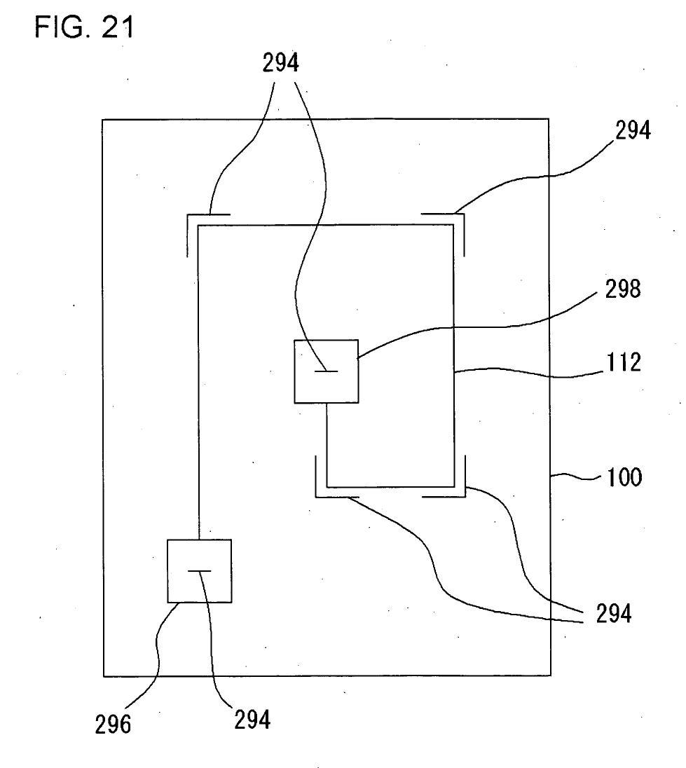

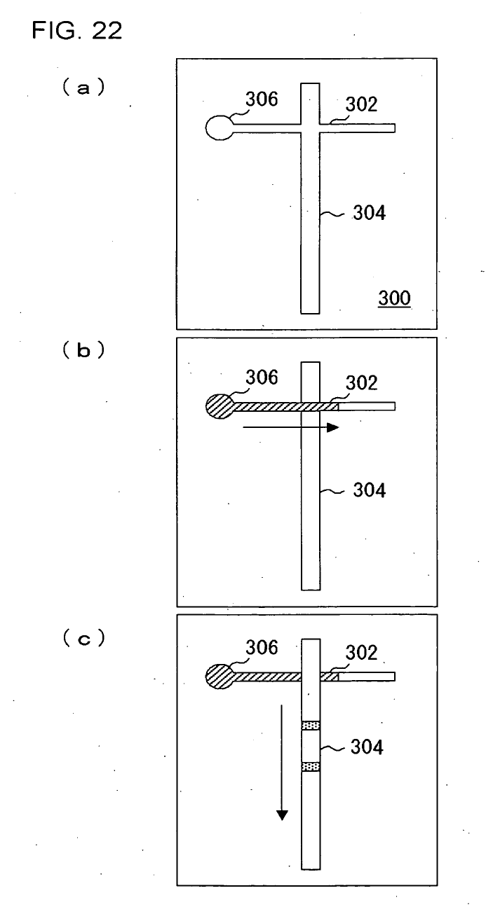

It is further allowable to configure the separation apparatus 100 as shown in FIG. 21. The channel for separation 112 has a sample introduction portion 298 and a sample recovery unit 296. Also in this configuration, there is provided an electrode 294 at each of the bent portions of the channel for separation 112, the voltage is applied so as to make the sample move downward in the drawing, and then applied so as to make the sample sequentially move rightward, upward, leftward and soon in the drawing. Also in this configuration, the individual divisional channel divided by the bent portions have different lengths, so that the components in the sample move through the channel for separation 112 at their specific migration speeds, and are fractionated in a concentrated manner in any of the divisional channels depending on their migration ranges.

The separation apparatus 100 described in the embodiments in the above are applicable to pre-separation for MALDI-TOFMS measurement. The next paragraphs will describe a sample preparation for protein MALDI-TOFMS, and the measurement.

For the MALDI-TOFMS measurement, it is necessary to decrease molecular size of proteins to be measured to as small as 1000 Da or around.

For a first exemplary case where proteins to be measured have disulfide bond in the molecule thereof, the proteins are reduced in a solvent such as acetonitrile or the like containing a reducing agent such as DTT (dithiothreitol). This makes it possible to efficiently proceed a decomposition reaction in the next stage. After the reduction, it is preferable to protect the thiol groups typically by alkylation, so as to prevent them from being re-oxidized.

Next, thus-reduced protein molecules are subjected to molecular size reduction treatment using protease such as trypsin. After the reaction, removal of trypsin and desalting are conducted as the molecular size reduction is proceeded in a buffer solution such as phosphate buffer. The protein molecules are then mixed with a matrix for MALDI-TOFMS, and dried.

The matrix for MALDI-TOFMS may appropriately be selected depending on substances-to-be-measured, and examples of which include sinapinic acid, α-CHCA (α-cyano-4-hydroxycinnamic acid), 2,5-DHB (2,5-dihydorxybenzoic acid), mixture of 2,5-DHB and DHBs (5-methoxysalicylic acid), HABA (2-(4-hydroxyphenylazo) benzoic acid), 3-HPA (3-hydroxypicolinic acid), dithranol, THAP (2,4,6-trihydroxyacetophenone), IAA (trans-3-indoleacrylic acid), picolinic acid, nicotinic acid and so forth.

The separation apparatus 100 in this embodiment can be formed on a substrate, and it is also allowable to pre-fabricate a pretreatment device, a dryer and so forth on the downstream side of the substrate, so as to make it possible to directly set the substrate to a MALDI-TOFMS apparatus. This makes it possible to carry out separation, pretreatment, drying and structural analysis of the target specific components on a single substrate.

The dried sample is set to the MALDI-TOFMS apparatus, voltage is applied, and a 337-nm nitrogen laser beam, for example, is irradiated to thereby conduct the MALDI-TOFMS.

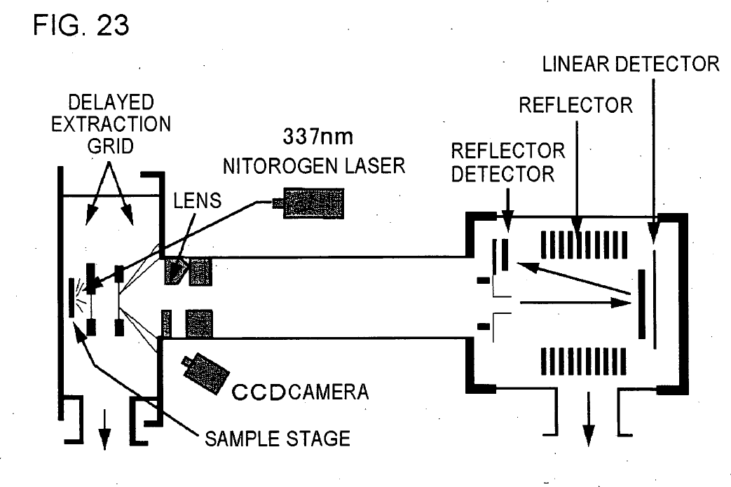

The next paragraphs will brief a mass spectrometry apparatus used in the present embodiment. FIG. 23 is a schematic drawing showing a configuration of the mass spectrometry apparatus. In FIG. 23, the dried sample is placed on a sample stage. Nitrogen gas laser having a wavelength of 337 nm is then irradiated in vacuo on the dried sample. The dried sample evaporates together with the matrix. The sample stage is configured as an electrode, and under voltage application, the evaporated sample makes flight in vacuo, and is detected by a detection unit including a reflector detector, a reflector, and a linear detector.

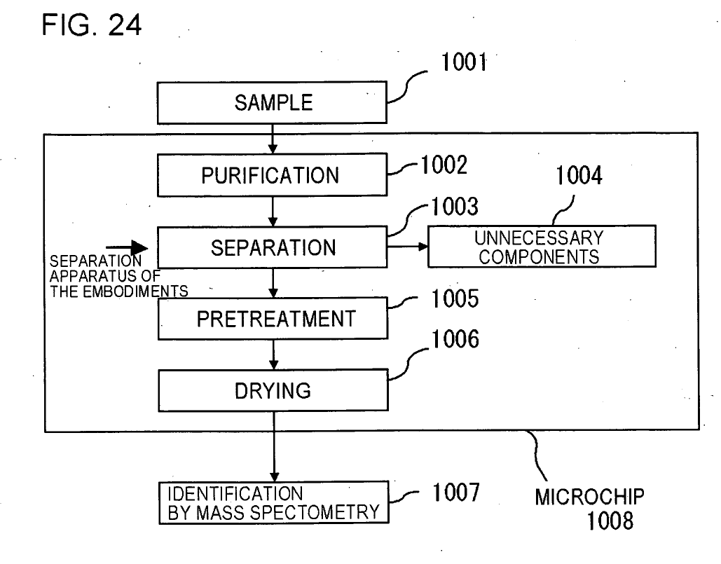

FIG. 24 is a block diagram of a mass spectrometry system including the separation apparatus of the embodiment. The system includes units executing, with respect to a sample 1001, the individual steps of purification 1002 removing impurities to a certain extent, separation 1003 removing unnecessary components 1004, pre-treatment 1005 of the separated sample, and drying 1006 after the pre-treatment. In the succeeding stage, identification 1007 based on mass spectrometry is carried out. These steps can be proceeded on a single microchip 1008.

Here, the reactor apparatus of the embodiment corresponds to the step of separation 1003.

As described in the above, the process flow of the embodiment makes it possible to efficiently and exactly identify a slight amount of component only with a small loss, by sequentially processing the sample on a single microchip 1008.

The present invention has been described based on the embodiments. It is to be readily understood by those skilled in the art that these embodiments are merely exemplary ones, allowing various modifications in any combinations of the individual constituents thereof and the individual treatment processes, and that such modifications are also within the scope of the present invention.

For example, the above embodiments have described the cases in which the individual compartments, or the individual divisional channels are differed in the length, but the effects similar to those obtained in the embodiments can be obtained also by varying magnitude of the external force to be imposed to the individual compartments or divisional channels, keeping the lengths of the individual compartments or divisional channels constant. In this case, it is preferable to reduce the magnitude of the external force for the portion on the channel closer to the destination of recovery.

As has been described in the above, the present invention can realize a separation apparatus allowing efficient separation by simple operations. The present invention makes it possible to accurately separate a sample, and recover it in a concentrated form.

1. A separation apparatus comprising:
a channel through which a sample containing components-to-be-separated moves;
one, or two or more check valves disposed in said channel, suppressing back flow of said components-to-be-separated;
a plurality of compartments partitioned by said check valve(s); and
an external force imposing unit imposing external force to said components-to-be-separated so as to allow them to move through said channel,
wherein said external force imposing unit has a function of alternately executing a first external force imposing pattern by which the external force is imposed to said components-to-be-separated in the forward direction along said channel, and a second external force imposing pattern by which the external force is imposed to said components-to-be-separated in the direction opposite to the forward direction along said channel, to thereby fractionate said components-to-be-separated into any of said compartments.

2. The separation apparatus according to claim 1, wherein said channel is formed so as to extend in a straight form.

3. The separation apparatus according to claim 1, wherein said check valves are formed so as to block back flow of at least a part of said components-to-be-separated flew through each of said check valves and moved to the downstream side of said channel.

4. The separation apparatus according to claim 1, wherein said external force imposing unit includes a plurality of electrodes provided to both ends of said channel, and has a function of executing said first external force imposing pattern and said second external force imposing pattern by changing direction of voltage to be applied between said electrodes.

5. A separation apparatus comprising:
a channel through which a sample containing components-to-be-separated moves;
interception units intercepting said components-to-be-separated moving through said channel in the sample forwarding direction of said channel;
a plurality of compartments partitioned by adjacent ones of said interception units; and
an external force imposing unit imposing external force to said components-to-be-separated so as to allow them to move through said channel,
wherein said external force imposing unit has a function of sequentially executing a plurality of external force imposing patterns differing in external force component in the sample forwarding direction in the channel in the individual compartments, so as to fractionate said components-to-be-separated into any of said compartments.

6. The separation apparatus according to claim 5, wherein said external force imposing unit is configured to impose external force so as to substantially equalize magnitude of the external force imposed to said components-to-be-separated in each of said compartments.

7. The separation apparatus according to claim 5, wherein said external force imposing pattern is such as imposing external force so that the compartments expressing a positive external force component and the compartments expressing a negative external force component alternately appear along the sample forwarding direction of said channel.

8. The separation apparatus according to claim 5, wherein said channel has a bent geometry, and a bent portion of said channel configures said interception unit.

9. (canceled)

10. The separation apparatus according to claim 5, further comprising recovery units recovering said components-to-be-separated fractionated into said individual compartments from said interception units,
wherein said external force imposing unit imposes external force also between each of said recovery units and said interception units, so as to move said sample towards said interception unit during fractionation of said sample, and so as to move said sample towards said recovery unit during recovery of said sample.

11. The separation apparatus according to claim 1, wherein said plurality of compartments placed along the sample forwarding direction of said channel are configured so that the one placed on the further downstream side of said channel has a larger length.

12. The separation apparatus according to claim 1, wherein said plurality of compartments placed along the sample forwarding direction of said channel are configured so that the one placed on the further downstream side of said channel is imposed with a smaller external force in said individual external force imposing patterns.

13. (canceled)

14. (canceled)

15. (canceled)

16. A separation apparatus comprising:
a channel having a main channel and sub channels formed as being branched out from said main channel, through which a sample including components-to-be-separated moves; and
an external force imposing unit imposing external force to said components-to-be-separated so as to allow them to move through said channel,
wherein said external force imposing unit is configured so as to sequentially execute a plurality of external force imposing patterns differing in direction of imposition of the external force relative to said channel, and said apparatus is configured so as to fractionate said components-to-be-separated into any of said sub channels, through execution of said plurality of external force imposing patterns.

17. The separation apparatus according to claim 16, wherein said main channel has a sample introduction port; and
said sub channels are configured so as to have said components-to-be-separated introduced thereinto when said external force imposing unit imposes external force towards the sample introduction port, and so as to move said components-to-be-separated towards said main channel when said external force imposing unit imposes external force in the direction departing from said sample introduction port.

18. (canceled)

19. (canceled)

20. (canceled)

21. A separation method using a separation apparatus comprising a channel through which a sample containing components-to-be-separated moves, a plurality of compartments provided to said channel, and an external force imposing unit imposing external force to said components-to-be-separated so as to allow them to move through said channel,
wherein said external force is repetitively imposed sequentially in the direction departing from a sample introduction position and in the direction approaching the position on said channel, to thereby fractionate said components-to-be-separated into any of said compartments.

22. The separation method according to claim 21, wherein said components-to-be-separated are fractionated into any of said compartments depending on migration ranges caused by imposition of said external force.

23. A separation method separating components in a sample using the separation apparatus described in claim 1, comprising:
a step of introducing said sample into said channel;
a first step of executing any one of said external force imposing patterns so as to move, within one compartment, said sample towards the downstream side of said channel;
a second step of executing any one of said external force imposing patterns so as to move, within one compartment, said sample towards the upstream side of said channel;
wherein these steps being sequentially repeated.

24. The separation method according to claim 23, wherein duration of time of imposing the external force is kept constant for every execution, in said external force imposing pattern in said first step.

25. The separation method according to claim 23, wherein duration of time of imposing the external force is kept constant for every execution, in said external force imposing pattern in said first step, and in said external force imposing pattern in said second step.

26. The separation method according to claim 23, wherein duration of time of imposing the external force in said external force imposing pattern in the second step is adjusted to substantially equal to, or longer than the duration of time of imposing the external force in said external force imposing pattern in the first step.

27. (canceled)

28. (canceled)

29. (canceled)

30. A separation method separating components in a sample using the separation apparatus described in claim 16, comprising:
a step of introducing said sample into said channel;
a first step of executing, in said main channel, any one of said external force imposing patterns so as to move said sample towards the downstream side of said channel;
a second step of executing, in said main channel, any one of said external force imposing patterns so as to move said sample towards the upstream side of said channel;
wherein these steps being sequentially repeated.

31. The separation method according to claim 30, wherein in said external force imposing pattern in said first step, duration of time of imposing the external force is kept constant for every execution.

32. (canceled)

33. (canceled)

34. A system comprising an external force switching control unit executing the method described in claim 21.

35. A mass spectrometry system comprising:
a pre-treatment unit separating a biological sample depending on the molecular size or properties, and subjecting said sample to a pre-treatment for an enzyme digestion treatment;
a unit subjecting said sample pre-treated by said pre-treatment unit to the enzyme digestion treatment;
a drying unit drying the enzyme-digestion-treated sample; and
a mass spectrometry unit subjecting the dried sample to mass spectrometry, wherein
said pre-treatment unit comprises a microchip described in claim 1.
